(19) United States
(12) Patent Application Publication
(10) Pub. No.: US 2003/0026268 A1
(43) Pub. Date: Feb. 6, 2003

(54) Characteristic routing

(75) Inventor: Julio Cesar Navas, Concord, CA (US)

Correspondence Address: Siemens Corporation, Attn: Elsa Keller, Legal Administratior, Intelllectual Property Department, 186 Wood Avenue South, Iselin, NJ, 08830, US

(73) Assignee: Siemens Technology-To-Business Center, LLC, Berkeley, CA

(21) Appl. No.: 10/096,154

(22) Filed: Mar. 11, 2002

Related U.S. Application Data
(63) Continuation-in-part of application No. 09/728,380, filed on Nov. 28, 2000.
(60) Provisional application No. 60/275,429, filed on Mar. 12, 2001.

(51) Int. Cl. H04L 12/28

(52) U.S. Cl. 370/400; 370/389

(57) ABSTRACT

A routing protocol, called characteristic routing, which allows data to be transported multi-hop through an internetwork from a sender to a set of receiver nodes using a description of the receiver nodes in the form of multiple arbitrary identifying descriptive names (called characteristics). Host nodes can have multiple dynamic characteristics. Characteristic routing is optimized to make the multiple-name case operate in a fast manner. In particular, characteristic routing creates an efficient routing table index using bit vectors and compression techniques. Using characteristic routing, the sender can choose whether the receiver nodes need to exactly match the characteristic routing address or certain characteristics in the routing address, or whether the receiver nodes can be simply “similar” to the characteristic routing address, or whether the receiver nodes have desired ranges of characteristics.

### CROSS-REFERENCE TO RELATED APPLICATIONS

The present non-provisional patent application claims priority from commonly owned provisional U.S. patent application No. 60/275,429 filed Mar. 12, 2001. The present application is also a continuation-in-part of commonly owned non-provisional U.S. patent application Ser. No. 09/728,380 filed on Nov. 28, 2000 (entitled “Characteristic Routing” and listing inventor Julio Cesar Navas).

### BACKGROUND OF THE INVENTION

The present invention relates to network data transport. More specifically, the invention relates to a network routing protocol that enables particularly fast multi-hop routing of data over an internetwork from a sender node to a set of multiple destination nodes using a description of set of destination nodes in the form of multiple identifying descriptive names or “characteristics.”

### Unicasting

Conventional network data transport approaches are often limited in their ability to provide fast multi-hop routing of data by a sender over an internetwork to a set of multiple destination nodes based on a combination of particular characteristics, where the combination can be dynamically changed by a sender depending on the type of data being sent. These conventional approaches are discussed below.

The most common type of conventional network data transport, especially in the Internet, is “unicasting.” With unicasting, it is assumed that computer hosts on an internetwork have a single unique identifier or “name” and that data will be sent from a single sender node to a single receiver node. However, this unicast name is purely functional and not descriptive. Implementation efficiencies depend upon the fixed address structure and the Internet address distribution pattern, which assigns names to hosts on the same network in such a way that all of the hosts on a network or related networks share the same address prefix. In particular, conventional routers are optimized for the single host name case because they often use a data structure, called patricia trees, that relies on a host's single Internet Protocol (IP) address having exactly 32 bits. In order for unicasting to function correctly, all of the routers must participate in some routing protocol that discovers the topology of the network before any data can be transported. This has the benefit of being able to know immediately if a particular packet of data is deliverable or not since each router has its own list of possible destinations in its routing table.

Using the most common unicast protocol for routing messages through an internetwork, or “link-state routing” (the most common instantiation of link-state routing is Open Shortest Path First (OSPF), such as described by J. Moy in RFC 2328 entitled “OSPF Version 2” (April 1998), and a similar version of link-state routing also is described in U.S. Pat. No. 5,128,926 issued to Perlman et al.), each router gathers information a priori about the topology of the network and then distills from that information a unicast routing table. The routers could then use this information to determine the best path from the sender to the receiver, and the original network topology information is retained by the routers. The information gathered about the network could include preferred routes or multicast membership (such as described by J. Moy in RFC 1585 entitled “MOSPF: Analysis and Experience” (March 1994)). All hosts and networks are assumed to have only a single primary address. Accordingly, unicasting is limited to providing routing of data by a sender over an internetwork only to one destination node based on that node's unique address. The single primary address as destination is assumed to be the general case, and the routing protocols are optimized to make this single address destination case work best. The link-state routing protocols in use today would have to be significantly improved in order to allow hosts to have multiple primary addresses (or characteristics) as the general case.

### Multicasting

In addition to unicasting, another common type of conventional network data transport is “multicasting,” which allows sending data from a sender to a group of receivers through an internetwork using a single address for the group. In accordance with multicasting, all hosts and networks, in addition to having their single primary address for unicasting, are also allowed to have multiple multicast addresses. The multicast protocol is described in a Ph.D. thesis by S. Deering in “Multicast Routing in a Datagram Internetwork” (Stanford Technical Report STAN-CS-92-1415, Dept. of Computer Science, Stanford University, December 1991). Multicast groups are considered “open” because anyone, whether they are a member of the group or not, can send data to a multicast group. This group is defined by a single address, and computer hosts can dynamically choose to join or leave a multicast group in order to begin or end the reception of the multicast transmission. However, the group members remain anonymous, and the senders often do not even know the size of the group. Therefore, a sender does not know if anyone is actually receiving the data that was transmitted (multicasting is similar to a radio station which broadcasts a radio program on a specific channel and people who wish to receive the broadcast can tune to the particular channel). Each host can be a member of multiple multicast groups and, therefore, can have multiple “names.” However, a host can only be addressed by one group or name at a time because the group addresses cannot be combined in any efficient way. Therefore, because of the anonymity of the receivers, multicasting can be inefficient because the routers do not know where to deliver the data.

Two conventional approaches to solving the multicasting inefficiency are “dense-mode multicast” and “sparse-mode multicast,” which are discussed further below. Dense-mode multicast is typified by the approaches initially taken in Deering's Ph.D. thesis and discussed in RFC 1585 (both mentioned above). Sparse-mode multicast is discussed by D. Estrin et al. in RFC 2362 entitled “Protocol Independent Multicast-Sparse Mode (PIM-SM): Protocol Specification” (June 1998).

The dense-mode multicast protocol solves the multicast receiver anonymity problem by broadcasting the first packet throughout the internetwork in order to reach everyone. Those hosts who do not want to receive the data stream have to opt out by sending a prune message back to the sender. The end result is that the routers have a shortest path tree from the sender to the receiver. However, because the initial broadcast has to be used in order to determine this tree, dense-mode multicast is not considered a network-friendly protocol. U.S. Pat. No. 4,740,954 issued to Cotton et al. tried to improve upon the original design by designating a network-wide spanning tree through which the initial broadcast had to be channeled. However, this approach still requires an initial broadcast to be used.

The sparse-mode multicast protocol, on the other hand, uses a multicast group “coordinator” in order to solve the multiple receiver anonymity problem. When the first sender or receiver for a multicast group appears, the nearest router becomes the coordinator for this multicast group and immediately begins to inform all other routers that it is the coordinator for the group. Hosts that wish to receive the data streams for this multicast group must now opt in by specifically telling the coordinator that they wish to be a receiver. In the end, the coordinator creates a single tree for that multicast group, called a core-based tree, with itself as the root. Using a single tree allows the sparse-mode multicast protocol to be used on wide-area internetworks with a minimum of disruption. However, the path that data travels from a sender to the set of multiple receivers is not the optimal shortest-path. U.S. Pat. No. 5,355,371 issued to Auerbach et al. tried to refine the sparse-mode protocol by having the tree leader or coordinator dynamically assign a group address to a new mulficast group by negotiating with all of the receivers to ensure the uniqueness of the group address.

### Multiple Naming Schemes for End-Points

Besides multicasting, other conventional data transmission systems either have allowed computer hosts to have multiple names or have used characteristics of a receiver to determine whether a particular user should receive a broadcast data transmission. However, such systems suffer from various problems, as discussed below.

### Broadcast and Filter

A conventional system using characteristics of a receiver to determine whether a particular user should receive a broadcast data transmission is described in U.S. Pat. No. 5,636,245 issued to Ernst et al. This system is an information radio broadcasting system that determines whether information broadcast by a general transmitter is relevant to a particular user based on the user's location, velocity, and/or time. One or more of the following would describe each message: a segment that includes a characteristic region, a velocity, a time corresponding to an event, an event specific tag. The selection criteria may also include arbitrary event specific tags. The receiver at the remote terminal receives the messages from the transmitter at the general broadcasting unit. The computer host evaluates the segment in the messages and determines if the segment sufficiently matches the stored selection criteria. If a match is found, then the host computer receives the message. Disadvantageously, this system does not provide multi-hop capabilities, since it assumes that all receivers are within range of the single transmitter.

Another conventional system using characteristics of a receiver to determine whether a particular user should receive a broadcast data transmission is described in U.S. Pat. No. 5,095,532 issued to Mardus. Mardus describes a system for route-selective reproduction of digitally encoded traffic announcements broadcast by a transmitter to a vehicle receiver. A comparison of the route-specific characteristics in the broadcast announcements is made with characteristics of the receiver's trip route. If the characteristics match (up to some threshold), the driver is provided with the traffic announcement applicable to him so that the driver is not distracted by a great number of traffic advisories that are not relevant for him. However, the system of Mardus, which employs only a single transmitter, does not provide multi-hop routing capability or make efficient use of network bandwidth, and suffers the same bottleneck and point-of-failure problems as the system described by Ernst et al. The Mardus system simply transmits all of the information and lets the receivers filter out the information that belongs to them.

### Geographic Routing

Yet another system that allows computer hosts to use a geographic characteristic of a receiver to determine whether a particular user should receive a broadcast data transmission is described by J. C. Navas and T. Imielinksi in “Geographic Addressing and Routing” (Proceedings of the Third ACM/IEEE International Conference on Mobile Computing and Networking (MobiCom '97) in Budapest, Hungary, September 26-30 1997). This system performs routing of packets through an internetwork using only geographical criteria. In this system, a sending host would address a packet for a contiguous geographical region by specifying the destination as a bounding polygon whose points are defined using longitude and latitude. Only hosts within the geographic area would receive the transmitted message. While this system also uses a routing approach in order to transport messages to a set of receivers, it specifically only routes based on geographical criteria.

### Directory Systems

Differing in its approach from the above-described systems, one conventional system provides mapping of addresses to allow computer hosts to have multiple names. This system is the Domain Name System (DNS), which was intended to enable hosts in multiple private networks to be able to communicate with each other. DNS is described in U.S. Pat. No. 5,777,989 issued to McGarvey and by P. Mockapetris in RFC 1035 entitled “Domain Names—Implementation and Specification” (November 1987). A separate DNS system would be used for each “domain” of host names, and each computer host would be allowed to have multiple “names.” Although this DNS system allows a computer host to have multiple names, it does so in an inflexible and brute force manner that requires a lot of overhead. In particular, when a first computer host wishes to converse with a second computer host with a particular name, the first host contacts all of the DNS domains until one of them returned a network address for the desired host name. Moreover, the DNS system does not provide routing based on multiple characteristics of destination hosts.

From the above, it is seen that a system is needed for allowing hosts in an internetwork to have multiple identifying descriptive names/characteristics and, yet, still be able to efficiently transport data/messages over multiple hops to multiple recipients using any arbitrary mix of these names/characteristics. Furthermore, in such a system, the data should be delivered to hosts who either exactly match the arbitrary mix of names specified as the destination address of the data or are only similar to the destination address.

### SUMMARY OF THE INVENTION

The present invention provides a system and methods that enable hosts in an internetwork to have multiple identifying descriptive names/characteristics and still be able to efficiently transport data/messages over multiple hops to multiple recipients using any arbitrary mix of these names/characteristics. The present invention also allows data to be delivered to hosts who either exactly match the arbitrary mix of names specified for destinations of the data or are only similar to the arbitrary mix of names specified.

According to a specific embodiment, the present invention provides a method for routing a packet over a network including multiple nodes. The method includes the step of sending a packet from a sender node over the network, wherein the packet is intended for at least one destination node having multiple defined characteristics being determinable by the sender node, and wherein the packet includes information on the multiple defined characteristics. The multiple defined characteristics is a subset of or a total set of multiple, arbitrary characteristics describing aspects of the multiple nodes in the network. The method also includes the step of discovering a topology of the network based on the total set of multiple arbitrary characteristics. The network couples the sender node, at least one destination node, and at least one routing node. The discovering step is performed reactively after the packet is sent from the sender node and the packet is received at the first of the routing nodes. In other embodiments, the discovering also can be performed proactively before the packet is sent from the sender node and the packet is received at the first of the routing nodes. The discovering step is either proactive or reactive depending on the network environment conditions. For example, reactive discovery is preferred in a low-bandwidth resource-poor unreliable network. The method also includes the step of configuring a routing table in soft state at each routing node of the topology of network portions intermediate respective to the first of the routing nodes. The routing table includes entries based on the particular characteristics of each node in the network portions. The method also includes the step of sending a copy of the packet based on the entries in the routing table to at least one destination node having the multiple defined characteristics.

According to another specific embodiment, the present invention provides a method for efficient hierarchical routing in a low bandwidth network or in an unreliable network. The method includes steps of representing a set of characteristics for a characteristic destination as a bit vector, approximating the set of characteristics to provide a limit on an overall size of the bit vector representing the set of characteristics, and transmitting over the network a message utilizing the approximated set of characteristics. The approximating step includes utilizing a compression technique such as Bloom filters.

According to another specific embodiment, the present invention provides a method of automatically configuring a characteristic network into a hierarchical organization. The characteristic network includes multiple characteristic routers and multiple nodes. The method includes the steps of discovering a topology of the characteristic network using a routing algorithm at each characteristic router. The routing algorithm includes choosing multiple non-overlapping groups of characteristic routers that are connected and contiguous such that each characteristic router in the characteristic network belongs to exactly one group. The method also includes the steps of determining membership of particular characteristic routers in particular non-overlapping groups by inspecting relationships between the characteristic routers, and regulating a size of each of the non-overlapping groups as individual characteristic routers either join or leave the characteristic network.

These and other specific embodiments are described in further detail below in conjunction with the following drawings.

### BRIEF DESCRIPTION OF THE DRAWINGS

FIG. 1 illustrates sending a message using multicast to network nodes having the combination of names A, B, and C, where each name represents a multicast group, in accordance with a prior art multicast approach.

FIG. 2 illustrates sending a message using characteristic routing to network nodes having the combination of characteristics A, B, and C, in accordance with a specific embodiment of the present invention.

FIG. 3 generally illustrates a characteristic routing system, according to a preferred embodiment of the present invention.

FIG. 4 is a generalized functional diagram of a characteristic routing node, according to a specific embodiment of the present invention.

FIG. 5 illustrates sending a message using approximated characteristic routing to network nodes having the combination of characteristics A, B and C, and pruning excess routing tree branches, in accordance with a specific embodiment where an approximation of the set of total characteristics is used.

FIG. 6 illustrates the network stack locations of various internetwork protocols according to the prior art.

FIG. 7 illustrates the format of a characteristic packet's globally unique identifier, according to a specific embodiment.

FIG. 8 shows the format of a characteristic destination (or list of characteristics) that includes two elements (characteristics) making up the characteristic destination of a charcast packet, in accordance with a specific embodiment.

FIG. 9 shows an Option Type field set to the characteristic IP option, in accordance with a specific embodiment.

FIG. 10 shows an IP header with a characteristic routing option extension, in accordance with the specific embodiment.

FIG. 11 shows an example of a characteristic routing packet that uses a characteristic header immediately after the IP header, in accordance with another specific embodiment.

FIG. 12 illustrates the network stack locations of characteristic extensions CharOSPF, CharRIP and CharBP to existing network topology configuration protocols, in accordance with various specific embodiments of the present invention.

FIG. 13 illustrates the CharOSPF Options field according to a specific embodiment.

FIG. 14 illustrates an example of a Characteristic-Area-LSA packet used in CharOSPF, in accordance with the specific embodiment.

FIG. 15 shows as an example a CharRIP packet, in accordance with another specific embodiment.

FIG. 16 shows as an example a CharBP packet, in accordance with the specific embodiment.

FIG. 17 is an exemplary diagram illustrating pointer links between cache entries in a characteristic router's cache and the characteristic router's routing table entries, in accordance with a specific embodiment.

FIG. 18 is an exemplary diagram demonstrating how a characteristic router's cache unintentional expiration can effectively de-link the downstream tree from the rest of the routing tree.

FIGS. 19 and 20 are exemplary diagrams demonstrating how the present invention addresses the potential problem of a characteristic router's cache unintentional expiration, in accordance with a specific embodiment.

FIG. 21 shows a network characteristic destination stored as a Bloom filter having k=4 such that the characteristic is represented by its four hash function results, according to a specific embodiment for hierarchical characteristic routing.

FIG. 22 illustrates an encoding of a characteristic list 701 (this example shows an AND list having two list elements), in accordance with a specific embodiment for hierarchical characteristic routing.

FIG. 23 shows a general method of creating a hierarchical characteristic network, according to specific embodiments.

### DETAILED DESCRIPTION OF THE SPECIFIC EMBODIMENTS

I. General

II. Characteristic Routing System

A. Characteristic Node Components

B. Characteristic Vectors

1. Characteristic Vectors: Closed vs. Open Sets of Characteristics

2. Approximating a Set of Characteristics

C. Characteristic Packets

1. Implementations Below IP

2. Implementations in the Network Layer

3. Implementations Above IP in the Transport Layer

a. CharOSPF

b. CharRIP

c. CharBP

D. Characteristic Routing Forwarding Cache and Routing Trees

E. Exposing Route Information

III. Hierarchial Characteristic Routing Embodiments

A. General

B. Encoding Characteristics With Bloom Filters

C. Gathering Characteristics About a Network Segment

D. Exchanging Routing Table Information

E. Automatically Configuring into a Hierarchical Network

IV. Low-bandwidth unreliable networks

V. Conclusion

I. General

Characteristic routing is a new routing protocol which allows data to be transported multi-hop through an internetwork from a sender to a set of receivers using a description of the receivers in the form of multiple arbitrary identifying descriptive names. An identifying descriptive name is called a “characteristic” and can be any descriptive single word. For instance, a factory temperature sensor could have the characteristics “temperature” and “sensor.” Note that receivers can have multiple characteristics, and these characteristics can be acquired by a host or removed in a dynamic fashion.

Examples of applications where characteristic routing can be used are in information management of distributed sensor networks, control of industrial automation networks, communication relating to logistics or the locations of objects, and other environments where messages are desired to be sent to nodes/objects having certain characteristics determinable by a sending node.

Characteristic routing, unlike unicasting which is optimized to make the single-address routing case fast, allows multiple names per computer host on the network and is optimized to make the multiple-address routing case fast. The characteristic routing system creates an efficient routing table index that, unlike the patricia tree, assumes that each destination will have multiple arbitrary and unstructured names. Unlike unicasting which only allows data to be sent from one sender to one receiver, characteristic routing enables a sender to transmit data to multiple receivers at the same time. When sending data, the sender can use an arbitrary mix of names/characteristics to address the set of receivers. Using characteristic routing, the sender can choose whether the receivers need to exactly match the characteristic address (like unicasting) or whether they can be simply “similar” to the characteristic address.

Characteristic routing according to the present invention differs from multicast in several respects. First, in a specific embodiment, characteristic routing solves the anonymity problem by using a modified link-state routing protocol to preemptively gather information about the network topology and the names (or characteristics) of the hosts associated with it. When a packet is transmitted, this information is used in order to determine where the packet should go. Also, senders know immediately whether the data that they send will actually reach receivers, because the routers have sufficient information to inform them whether their data is deliverable or not. Second, the sender can use an arbitrary mix of characteristics in order to define the intended receivers for the message. Multicast, however, only allows one address per group and these addresses cannot be combined in any efficient way in order to reach some combination of multicast groups. Third, characteristic routing is more network-friendly than dense-mode multicast, because only routers on the shortest path from the sender to the set of receivers are affected with characteristic routing. Fourth, characteristic routing is more optimal than sparse-mode multicast, because every routing tree is a shortest-path routing tree rooted at the sender and not at some arbitrary “coordinator” router.

The ability to use an arbitrary mix of names (or characteristics) when defining the intended receivers of a “charcast message,” described in detail below, is one of the advantages that characteristic routing has over other routing technologies such as multicast or unicast.

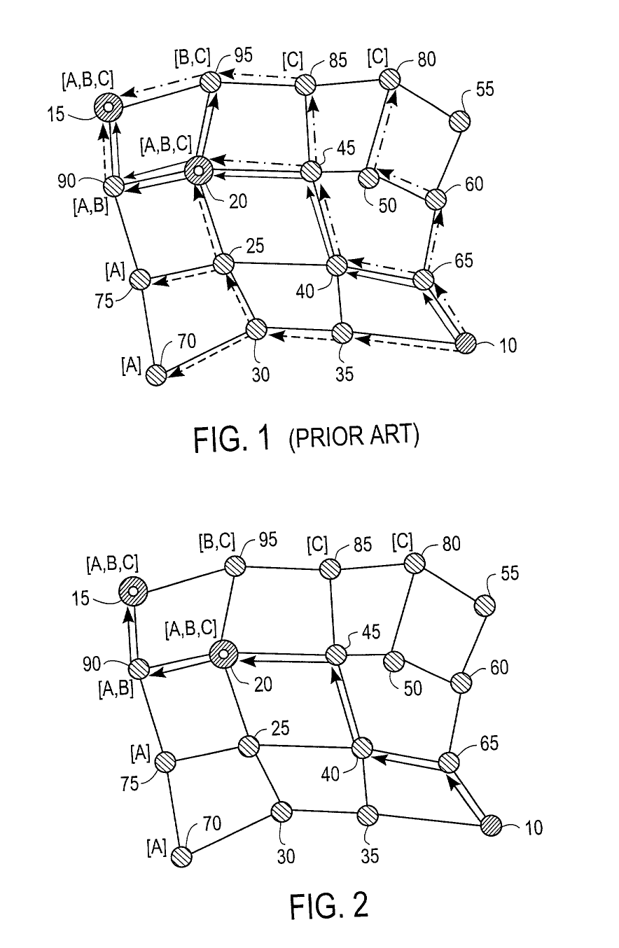

FIGS. 1 and 2 illustrate the advantages of characteristic routing over multicast routing using a specific example where a sender node desires to send a message to all nodes having particular characteristics (e.g., characteristics A, B and C). In particular, FIG. 1 illustrates sending a message using multicast to network nodes having the combination of names A, B, and C, where each name represents a multicast group, in accordance with a prior art multicast approach. As discussed later, FIG. 2 illustrates sending a message using characteristic routing to network nodes having the combination of names A, B, and C, where each name represents a characteristic, in accordance with a specific embodiment of the present invention. In FIGS. 1 and 2, for simplicity, the network nodes shown are routing nodes that have host nodes (not shown) coupled thereto capable of having the names A, B, C, or a combination thereof, and the sender node is a routing node having a sender host node that sends the message.

In this example, consider an arbitrary network where there exist multiple nodes that have names of A, B, and C, as seen in FIGS. 1 and 2, and a sender node wishes to send a message to those nodes who have all three names (in other words, nodes who have the names A and B and C). In this example, of the desired three names, only nodes 10 and 15 have all names A, B and C; nodes 25, 30, 35, 40, 45, 50, 55 and 60 do not have any of the names A, B or C; nodes 70 and 75 have only the name A; nodes 80 and 85 have only the name C; node 90 has only the names A and B; and node 95 has only the names B and C.

For FIG. 1, where the sender is using multicast, each name would be a multicast group address. But since multicast by itself does not allow routing based on a combination of groups, a sender node 10 would have to split the message into three parts and multicast each part to a different multicast group. In this way, only the nodes 15 and 20 that are members of all three multicast groups (A, B and C) would receive the whole message desired to be sent by node 10. As will be explained further, the result using multicast is greater network disruption and many unintended receivers.

In particular, as seen by the various arrows indicating message forwarding among nodes, sender node 10 sends a first multicast to all members belonging to the first multicast group A, a second multicast to all members belonging to the second multicast group B, and a third multicast to all members belonging to the third multicast group C. In sending the first multicast (shown by dotted line arrows) to group A, sender node 10 sends the first network message to node 35, which forwards a copy of the first network message to node 30, which then forwards a copy of the first network message to nodes 70 and 25. Then, node 25 forwards a copy of the first network message to nodes 75 and 20, and node 20 forwards a copy of the first network message to node 90, which forwards a copy to node 15. In sending the second multicast (shown by solid line arrows) to group B, the sender node 10 sends the second network message to node 65, which forwards a copy of the second network message to node 40, which then forwards a copy to node 45. Node 45 then sends a copy of the second network message to node 20, which forwards a copy of the second network message to nodes 90 and 95. Node 95 then forwards a copy of the second network message to node 15. In sending the third multicast (shown by dash-dotted line arrows) to group C, the sender node 10 sends the third network message to node 65, which forwards a copy of the third network message to nodes 40 and 60. Nodes 40 and 60 forward copies of the third network message to node 45 and node 50, respectively. Then, node 50 forwards a copy of the third network message to node 80, and node 45 forwards copies of the third network message to nodes 20 and 85. Node 85 further forwards a copy of the third network message to node 95, which forwards a copy on to node 15. As described above for this specific example, eight hops are involved in sending the first network message to members of group A, seven hops are involved in sending the second network message to members of group B, and ten hops are involved in sending the third network message to members of group C. Therefore, when a sender tries to send an entire message (made up of the first, second and third network messages) using multicast to those nodes having names A, B and C, many other nodes (such as endpoint nodes 70, 75, 80, 85, 90 and 95; and the remaining routing nodes) unnecessarily receive at least a portion of the entire message that is intended for nodes 10 and 15 having names A, B and C. This can result in unnecessary network traffic congestion due to various network messages traveling the network.

In contrast, when using the characteristic routing system of the present invention, the sender node 10 simply specifies that the receiver nodes must have all three names A, B, and C in order to receive the message (a message sent using characteristic routing according to the present invention is referred to as a “characteristic message”). Characteristic routing would then transport the characteristic message by the shortest path from the sender to the receivers. Since the original exact set of names was used to determine the next hop at each router, the optimal routing tree from the sender to the receiver is created. In particular, as illustrated in FIG. 2, the sender node 10 sends a characteristic message (shown by solid line arrows) to node 65, which forwards a copy of the characteristic message to node 40, which forwards a copy to node 45. Node 45 then forwards a copy of the characteristic message to node 20, which forwards a copy of the characteristic message to node 90, which then forwards a copy to node 15. The arrows in FIG. 2 denote the routing tree created using characteristic routing. Therefore, when a sender sends a characteristic message using the present invention to only those nodes having names A, B and C, only a minimal amount of nodes (routing nodes 65, 40, 45 and 90) necessary to the routing of the message to the desired nodes receive a copy of the characteristic message that is intended for nodes 10 and 15 having names A, B and C. This example, as described with FIGS. 1 and 2, illustrates that characteristic routing according to the present invention greatly minimizes the number of mistaken endpoint receiver nodes and network traffic congestion, compared to multicast routing.

In characteristic routing, the system is designed to allow computer hosts to have multiple names (characteristics). Characteristic routing can be broadly and flexibly used since it can route a message based on arbitrary characteristics, with one of those characteristics being the location of the receiver, the type of receiver, or any number of qualities of the receiver. Furthermore, these names or characteristics can be acquired by a host or removed in a dynamic fashion with little overhead. With characteristic routing, as long as the receivers are within range of any transmitter, the characteristic messages will be forwarded from the sender to the receivers through possibly several intermediate routers until they reach their destinations.

Characteristic routing efficiently uses the available network bandwidth by constructing a shortest-path routing tree from each sender to all of the receivers. In this manner, the information travels only by the most direct route and only to the intended receivers. Routers using characteristic routing according to the present invention are referred to as “characteristic routers.” Characteristic routers have sufficient information in their routing tables to know whether data with a specific address is deliverable before they transport the data. In addition, it is noted that the term “characteristic router” is used in a general sense and may include traditional routers, network switches, gateways, bridges, or controllers which bridge separate networks, as long as the characteristic routing capabilities are resident thereon. Further, characteristic routing may be used in a wired network, wireless network, or combined wireless-wired network.

Using an augmented protocol for discovering the network topology and automatically configuring a routing table (various specific embodiments will be described further below), a characteristic router will have a routing table entry based on characteristics for each destination in the network. Each entry will then contain information on a destination's characteristics, IP address, the shortest number of intermediate routers between the current router and the destination, and the preferred neighbor router to use as the next step on the path to the destination.

When forwarding an incoming packet, a characteristic router uses routing table information to determine where the final destinations for the characteristic message reside and which neighbor routers should be sent a copy of the packet. First, using the characteristic information contained in the routing table and the message header, all of the final destinations for the packet are discovered. Then a list of the neighbor routers on the direct shortest paths to the destinations is created and a copy of the message is sent to each neighbor router on the list. When a characteristic message has been forwarded all of the way from the sender to all of the receivers, the routers will have created a shortest-path routing tree with the “root” at the sender and the “leaves” at all of the receivers. If the exact set of destination characteristics is used, then the routing tree will be optimal (as seen in the example of FIG. 2). In order to ensure that shortest-path routing tree is created, the characteristic router will only forward packets that arrive from the sender by the shortest path. If not, then the router simply responds with a “prune” message to the packet's previous hop and drops the packet, in some embodiments as discussed below.

In order to reduce the forwarding cost, the characteristic router keeps a cache of the next-hop destinations of the most recent characteristic message packets. When a router receives a characteristic message packet, it will use the incoming packet's sender IP address and set of destination characteristics together as a key into the cache. If this is not the first packet to arrive for this destination and if the timer on the cache entry has not yet expired, then the cache will return a list of all of the neighbor routers to which copies of the packet must be sent.

Various aspects of specific embodiments of the present invention described generally will be described in more detail below.

II. Characteristic Routing System

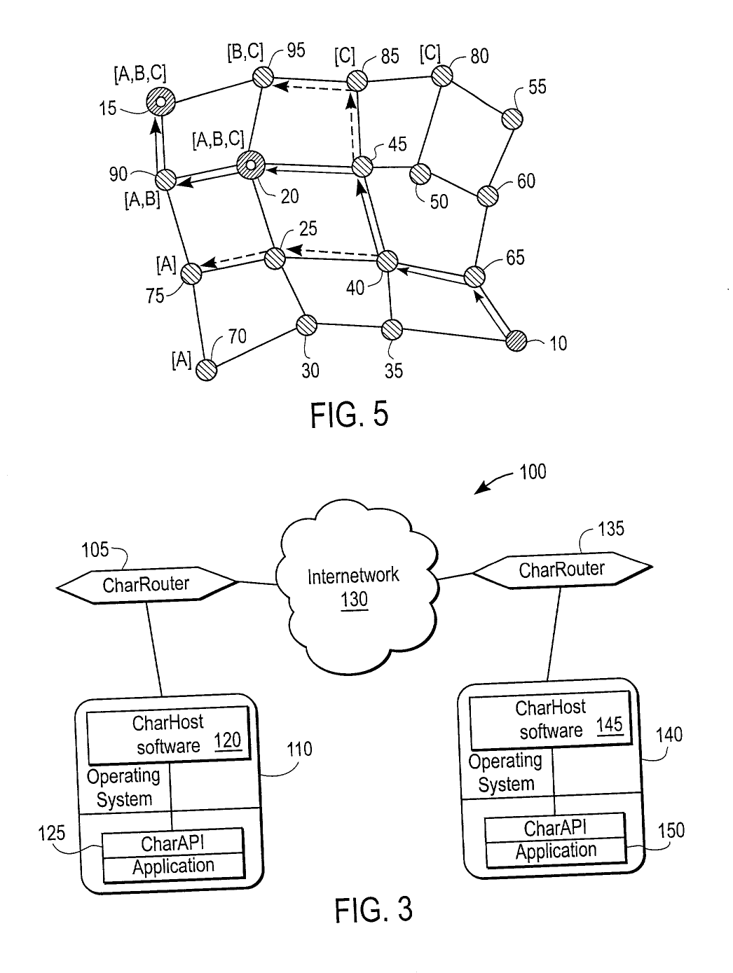

FIG. 3 generally illustrates a characteristic routing system, according to a preferred embodiment. According to this embodiment, the characteristic routing system 100 includes three main components: characteristic routing host software (“CharHost software”), characteristic application programming interface (“CharAPI”), and characteristic routers (“CharRouters”). Each of the nodes in FIG. 2 (and FIG. 5 discussed below) can be either a characteristic router node or a characteristic host node, as described herein.

When a host first boots, it declares to the local characteristic router the characteristics that describe the host. In this manner, the router can keep track of the various characteristics of the hosts on its networks. If the characteristic router needs to find out the characteristics of the hosts on its network (for example, when the router recovers from a crash), it broadcasts a Characteristic Address Resolution Protocol (CharARP) query. All of the hosts receive this broadcast and then respond with their characteristics. If the characteristic router needs to discover which node has a particular set of characteristics, it broadcasts a CharARP query and includes the specific characteristics of interest. Only those hosts with those characteristics will respond to this query.

In the general illustration of FIG. 3, system 100 includes a first CharRouter 105 coupled to a first characteristic host node 1 10, which includes CharHost software 120 and CharAPI 125. A second CharRouter 135 is coupled to first CharRouter 105 via an internetwork 130. Further, second CharRouter 135 is coupled to a second characteristic host node 140, which includes CharHost software 145 and CharAPI 150. The CharAPI is the set of software library routines that allow a programmer to create applications that can send and receive characteristic messages. The CharHost software is located on all computer hosts that are capable of receiving and sending characteristic messages. CharHost software is located in the Network Layer of the Internet protocol stack in the operating system of the computer. Its role is to notify all client processes about the availability of characteristic messages and to interface with the local CharRouter. The CharHost software also includes the client-side CharARP functionality described above.

As mentioned generally above, characteristic routers (CharRouters) are in charge of forwarding a characteristic routing message from a sender to a receiver through an internetwork. Each characteristic router is charged with performing characteristic routing functions for those networks to which it is assigned. CharRouters keep track of the local characteristics by creating a union of the characteristics of the computer hosts attached to the networks assigned to the CharRouter. CharRouters build their routing tables by exchanging the characteristics of their local networks. The CharRouter also includes the server-side CharARP functionality described above.

A. Characteristic Node Components

Routing involves two separate functions: control message exchange and packet forwarding. Control message exchange involves routers swapping routing table information and then having each router create a routing table from the network information that it accumulated. Packet forwarding involves each router using its routing table in order to decide the next hop for a packet that it receives.

In order to perform control message exchange in accordance with a specific embodiment of the present invention, a link-state routing protocol Open Shortest Path First (OSPF) protocol is augmented (to create CharOSPF, in accordance with a specific preferred embodiment, as discussed below) so that when a characteristic router is sending its routing table information to a neighboring characteristic router, it includes the characteristics of all of the destinations listed in its exchange information. As discussed below, other specific embodiments utilize augmented protocols besides CharOSPF.

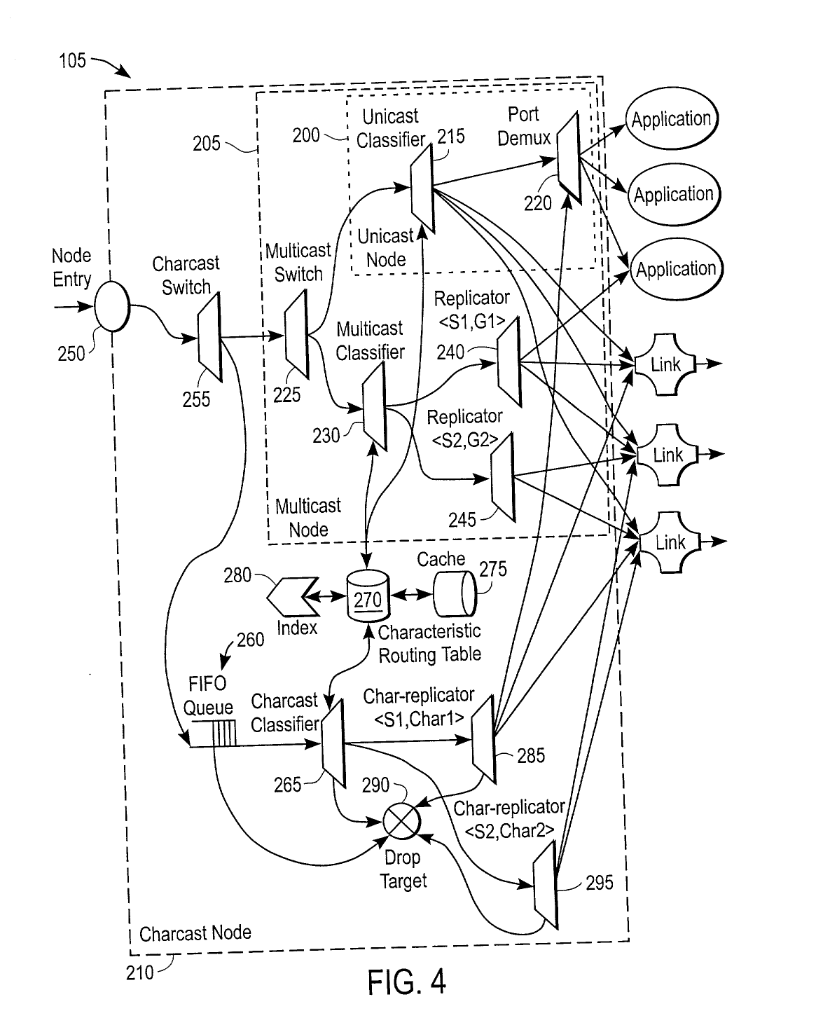

FIG. 4 is a generalized functional diagram of a characteristic routing node, according to a specific embodiment of the present invention. A characteristic node contains a characteristic routing functional component (“charcast” functionality) can allow it to act as a characteristic router (or “CharRouter”), in addition to acting as a conventional unicast and multicast router. As indicated in FIG. 4, a characteristic routing node, such as CharRouter 105 in FIG. 3, can be functionally thought to include a unicast functional component 200, a multicast functional component 205, and a charcast functional component 210. In some embodiments where the routing node is desired to only have limited functionality, such as only charcast functionality, the unicast and/or multicast functionalities may be omitted. However, in preferred embodiments, the characteristic router node includes all three of these functionalities. In still other embodiments, the charcast functionality may be included with other types of routing functionalities (different from unicast or multicast).

In the preferred embodiment of FIG. 4, the unicast and multicast functional components 200 and 205, respectively, are included with the charcast functional component 210 in node 105. In particular, unicast component 200 includes a unicast classifier 215 and a port demultiplexer 220. Unicast classifier 215 routes a packet using a unicast routing table. Port demultiplexer 220, using the destination port for the packet, sends the packet to the particular application currently using that particular destination port. Multicast component 205 includes a multicast switch 225, a multicast classifier 230, and a first replicator 240 and a second replicator 245. This example merely shows two replicators. However, an arbitrary number of replicators can be used, as a different replicator is created for each sender/multicast routing subset pair. Multicast switch 225 determines whether the packet should be routed using the unicast routing table or using the multicast routing table. Multicast classifier 230 routes a packet using the multicast routing table. A multicast replicator (240 or 245) actually transmits the packet to the outgoing links or to the internal port demultiplexer (if the packet is destined for an application on node 105). Further, node 105 includes a charcast functional component 210, as mentioned above, that provides the capability for node 105 to perform characteristic routing. Logically coupled to characteristic routing node 105 are various applications and communication links. Node 105, as shown in FIG. 4, includes a logical input port 250, where a packet is received by node 105, and a charcast switch 255 which determines whether the packet is a characteristic message packet.

If charcast switch 255 in node 105 has determined that a received packet is not a characteristic message packet, then the packet is routed to multicast functional component 205 for handling. More specifically, multicast switch 225 determines, based on the type of address from the packet's header, whether the packet should be routed using the unicast routing table or using the multicast routing table. If the packet has a multicast address, then multicast switch 225 sends the packet to multicast classifier 230, which routes the packet using the multicast routing table. Multicast classifier 230 then routes the packet to the appropriate multicast replicator (240 or 245) for transmission of the packet to the appropriate outgoing link(s) and/or node 105's application(s) (via port demultiplexer 220, if to an application). However, if the packet is determined by multicast switch 225 to have a unicast address, multicast switch 225 routes the packet to unicast classifier 215, which routes the packet using the unicast routing table. Unicast classifier 215 can route the packet to the appropriate outgoing link(s), or to internal port demultiplexer 220 for the appropriate application(s).

However, if charcast switch 255 in node 105 has determined that a received packet is indeed a characteristic message packet, then the packet is routed to the rest of charcast functional component 210 for handling. In particular, charcast functional component 210 also includes a first-in-first-out (FIFO) buffer 260, a charcast classifier 265, and a memory 270. Memory 270 stores a characteristic routing table (both the data that constitutes the routing table and the functions that will search and maintain the table, cache, and index), as well as the unicast routing table indexed by, e.g., a patricia tree, and the multicast routing table (and associated index, if existing), when unicast and multicast functional components are included in node 105. The characteristic routing table in memory 270 is coupled to its own index 280 and a memory cache 275, in a specific embodiment. Charcast functional component 210 also includes char-replicators (285, 295) and a function 290 to drop the target (i.e., discard the packet). Similarly as for replicators discussed above, this example merely shows two char-replicators. However, an arbitrary number of char-replicators can be used, as a different char-replicator is created for each sender/characteristic routing subset pair. The operation of the various parts of charcast functional component 210 in CharRouter node 105 will be described in more detail below.

After charcast switch 255 has inspected the packet's header and determined the presence of a characteristic destination, charcast switch 255 passes the packet to charcast classifier 265 to continue handling. (Otherwise, charcast switch 255 passes the packet to the multicast functional component 205 for handling, as already discussed above.) Charcast classifier 265 queries the characteristic routing table (stored in memory 270) in order to determine the proper destination and path for the packet, and manages the list of char-replicators (285, 295), which perform the actual physical forwarding of the packet. If another characteristic message packet arrives at node 105 during the time that the charcast classifier 265 is busy forwarding a previous packet, the new packet will be placed on FIFO queue 260. Once charcast classifier 275 has finished forwarding its previous packet, it will grab the next packet on the queue.

When charcast classifier 265 receives a characteristic message packet, it queries the characteristic routing table for the packet's next hop by passing the packet's destination characteristics to the table. The characteristic routing table responds to the query either by returning the identity of the appropriate char-replicator (285 or 295) that charcast classifier 265 needs to use in order to forward the packet, or by telling charcast classifier 265 that the packet cannot be forwarded.

The characteristic routing table first consults the unicast routing table to ensure that the packet arrived at node 105 from the sender by the shortest path. If it has not, then the packet cannot be forwarded and will be dropped (as indicated by drop target function 290). The characteristic routing table then uses packet's set of destination characteristics to search the routing table cache 275. Cache 275 stores forwarding information based on a packet's sender address and destination characteristics. Both have to match in order for cache 275 to return a successful hit. If a packet from this sender and for this destination have been seen before, then cache 275 will return the identity of the proper char-replicator to use. Then that proper char-replicator transmits the packet to the appropriate outgoing link(s) or, if appropriate, to port demultiplexer 220 for a resident application(s).

If no cache entry is found, then the characteristic routing table will search the routing table index 280 using the packet's destination characteristics. Index 280 will return a list of potential candidate destinations that have those characteristics. If no candidates are found by index 280, then the characteristic routing table will inform charcast classifier 265 that the packet cannot be forwarded. If candidates are found by index 280, the characteristic routing table will use its routing table entries to derive the set of next hops for the packet and it will encode this knowledge in a new char-replicator object. If the current node 105 qualifies as a destination, then one of the next hops encoded in the char-replicator will be a link to the current node's port demultiplexer 220. The characteristic routing table then installs the new char-replicator object in charcast classifier 265 and returns the identity of this new char-replicator to charcast classifier 265.

As mentioned above, the primary role of a char-replicator is to actually transmit a copy of a packet to each of its set of next hops. However, a char-replicator also performs a secondary role of being the mechanism for the pruning of overly-large routing trees, in specific embodiments where a set of characteristics is approximated, as discussed above. In addition to encoding the next-hop information for a particular <sender address, destination characteristics> pair, each char-replicator also contains the address of the previous hop. If the number of next-hops declines to zero, the char-replicator will then transmit a prune message to the previous hop. Just in case the prune message is lost and the characteristic message packets for the particular <sender address, destination characteristics> pair continue to arrive, the char-replicator object will continue to exist for a period of time past the last received packet and then it will be deleted. Each new packet that arrives will trigger a corresponding prune message to be transmitted to the previous hop.

B. Characteristic Vectors

The characteristics for a particular destination node in a routing table are kept as a vector of characteristics. The characteristic router assigns each unique characteristic a location on a bit vector. As discussed above, the various characteristics can be arbitrary and can be dynamically added (or removed) in some embodiments. An example of a vector of arbitrary characteristics is shown in Table 1 below.

TABLE 1
Vector of characteristics

| Characteristic | Bit Vector location |
|---|---|
| ASIC | 1 |
| Atomic | 2 |
| Curly | 3 |
| Defiant | 4 |
| DSP | 5 |
| Fast Fourier | 6 |
| Flash | 7 |
| Helium | 8 |
| Hydrogen | 9 |
| Larry | 10 |
| RAM | 11 |
| Star Trek | 12 |
| Stooges | 13 |
| Sub-band | 14 |
| Voyager | 15 |
| Wavelet | 16 |

As seen in Table 1, each unique characteristic is assigned a location in a bit vector (e.g., the “DSP” characteristic is assigned to the fifth bit vector location, where the number of the bit vector location indicates a position starting from the most significant bit, in a specific embodiment). In other embodiments, the number of the bit vector location can be a position starting from the least significant bit. According to this specific embodiment, a bit vector of a particular destination node that has the following characteristics (“ASIC,” “Atomic,” “Fast Fourier,” “Helium,” “Hydrogen,” and “Wavelet”) would have a resulting bit vector of “1100010110000001”. Encoding of each bit in the bit vector of characteristics can be implemented in various ways, such as discussed below.

Because bit vectors are being used, vector operations can be performed on the characteristics. For instance, in order to discover whether characteristic packet's destination characteristics match exactly with a routing table entry, a logical “AND” can be performed. If the resulting vector is equal to the original packet's destination characteristic vector, then an exact match is found. If only some of the destination characteristics need to be found, then a logical “AND” can be performed and if the result is simply greater than zero then at least some of the characteristics matched. In those situations where a message is desired to reach those nodes with at least one of the subset of destination characteristics, a logical “OR” can be performed and if the result is simply greater than zero then at least one of the characteristics matched. Since vectors can be considered to be lines in n-space (where n is the number of characteristics), the angle between the vectors can be found. Vectors that have a small angle between them can be considered “similar,” whereas those with large angles between them are not similar. In this manner, the sender node could even specify that a characteristic message be sent to those nodes having a particular characteristic bit vector that has a predefined degree of similarity based on the angular difference between the destination nodes' vectors and the desired bit vector of desired characteristics. Further, a “range” of characteristics inclusive between a starting characteristic and an ending characteristic can be specified by defining a starting characteristic (a particular starting vector bit) and an ending characteristic (a particular ending vector bit) in order to send a characteristic message to those nodes meeting all the characteristics within the defined range of characteristics.

For either direct characteristic matches or similar characteristic matches, the characteristic bit vector enables rapid processing with characteristic routing, which can operate with great speed as well as efficiency.

1. Characteristic Vectors: Closed vs. Open Sets of Characteristics

As mentioned above, in some specific embodiments, the characteristics used can be dynamically changed (removed or added), which can be useful for sending messages in changing environments where characteristics of nodes can vary as different nodes are added to (or removed from) the network.

If the set of characteristics is “closed” or static, then the set of characteristics throughout the network will not change and all routers will have the same set of characteristics and the same characteristic vectors. This allows the characteristic bit vector to be calculated by the sender and placed directly into the packet header.

However, if the set of characteristics is “open” or dynamic, each characteristic router may be operating with a different set of characteristics. This occurs because of the delay caused when a new characteristic appears in a network and is propagated throughout the network to all of the routers. At any one point in time, each characteristic router may not have the full set of characteristics existing in the network as a whole. Therefore, since the sender may not have the full set, it cannot calculate a characteristic vector and must list all of the destination characteristics in the packet header. Each characteristic router will then translate the list of characteristics into a characteristic vector consistent with the characteristic set known to that router.

2. Approximating a Set of Characteristics

If the network is using an “open” set of characteristics, it is possible that the number of characteristics can become large enough to put a strain on the system or, at least, make the resulting packet headers too large. Therefore, approximations are useful in some specific embodiments in order to reduce the number of characteristics that the system uses for characteristic routing. For example, various compression techniques can be utilized to significantly reduce the characteristic count.

Given a large string, compression techniques, such as Lempel-Ziv or Bloom filters (as will be discussed in more detail later) (other compression techniques are possible in other specific embodiments), obtain their space savings by creating a small set of substrings with which the whole original string can be recreated. The substrings and the instructions of how to use the substrings are then stored to recreate the original string. For characteristic routing purposes, the substring can be used as an approximation of the original set of characteristics. The senders and the routers would use this approximation technique. The first packet in a stream of packets would still have to send the original list of destination characteristics so that the endpoints can determine if these packets are really meant for them or not.

Because the compression techniques reduce the number of strings from the original number of characteristics to the smaller number of substrings, the characteristic routers in these embodiments have to do less comparison work, and therefore can route faster. Also, the routing tables would be significantly smaller.

Because of the loss of specificity, characteristic packets in these embodiments may be forwarded to nodes that shouldn't have received these packets in the first place and the resulting routing tree will contain extra erroneous branches that should be pruned. If a characteristic router detects that no downstream routers are viable destinations for a message and that it itself is not a destination of the characteristic message, then it will send a “prune” message upstream toward the source of the characteristic message. When a characteristic router receives a prune message for a specific characteristic message, it removes that downstream router from the routing cache entry (if any) for that characteristic message. If this causes the number of downstream routers to drop to zero, then the characteristic router will itself send a prune message upstream.

In accordance with a specific embodiment, FIG. 5 illustrates the process of pruning excess routing tree branches when an approximation of characteristics is used. For simplicity, FIG. 5 uses the same example network structure as described for FIG. 2. Similarly as for FIG. 2, for simplicity, the network nodes shown are routing nodes that have host nodes (not shown) coupled thereto having the names A, B, C, or a combination thereof, and the sender node is a routing node having a sender host node that sends the message. In FIG. 5, sender node 10 sends a characteristic message that uses an approximation of the set of total characteristics. Since an approximation of the set of characteristics is used to determine the next hope at each node, an overly large routing tree from sender node 10 to the receiver nodes is created. In particular, sender node 10 sends a characteristic message (indicated by solid line arrows and dotted line arrows) using an approximate set of characteristics (referred to as an “approximated characteristic message”) in order to send a message to nodes having A, B and C characteristics. This approximated characteristic message is sent to a node 60, which forwards a copy of the approximated characteristic message to node 40, which then forwards a copy of the approximated characteristic message to nodes 25 and 45. Then, node 25 forwards a copy of the approximated characteristic message to node 75, and node 45 forwards a copy of the approximated characteristic message to nodes 85 and 20. Node 85 forwards a copy of the approximated characteristic message to node 95, and node 20 forwards a copy of the approximated characteristic message to node 90 which then forwards a copy to node 15. As shown, the arrows denote the optimal routing tree (shown by solid line arrows, such as obtained when not using an approximation of the set of characteristics, as shown in FIG. 2) and extraneous branches (shown by dotted line arrows, obtained due to the use of the approximation) that need pruning, as will be described below.

C. Characteristic Packets

In order for packets to be routed using characteristic information, the characteristic routing protocol can reside in various network stack layers (e.g., data link layer 2, network layer 3, or transport layer 4 of the Open Systems Interconnect (OSI) protocol stack) according to various specific embodiments. The layer where the characteristic routing protocol resides influences and contributes to determining the interface and capabilities of the characteristic routing protocol. Various specific embodiments are discussed herein, and it is noted that different embodiments may be preferred for different situations.

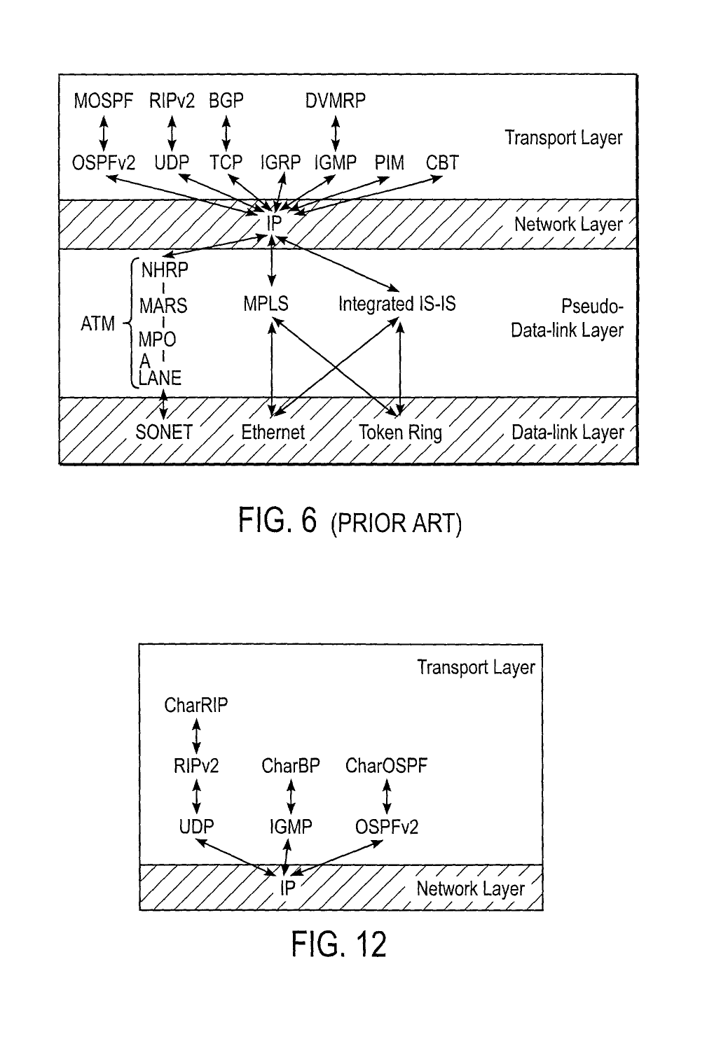

Ideally, specific embodiments of the characteristic routing protocol would be implemented in the network layer. Other specific embodiments of the present invention may be preferred where the characteristic routing protocol resides either (i) directly above the data link layer and below IP in a pseudo-data link layer, (ii) directly above IP in the transport layer, or (iii) directly above one of IP's transport layer (such as UDP or Transmission Control Protocol (TCP)). Useful in the context of discussing specific embodiments, FIG. 6 illustrates the network stack locations of various prior art internetwork protocols. As seen in FIG. 6, Asynchronous Transfer Mode (ATM), Integrated IS-IS, and Multi-Protocol Label Switching Architecture (MPLS) are examples of protocols operating in the Pseudo-Data Link layer. ATM protocols include Local Area Network Emulation (LANE), Multi-Protocol Over ATM (MPOA), Multicast Address Resolution Server (MARS), and Next Hop Resolution Protocol (NHRP). SONET, Ethernet and Token Ring are examples of protocols operating in the Data Link layer. OSPFv2, UDP, TCP, Inter-Gateway Routing Protocol (IGRP), Internet Group Management Protocol (IGMP), Protocol Independent Multicast (PIM) protocol, and Core-Based Tree (CBT) multicast protocol are examples of protocols operating in the transport layer directly above IP. Multicast extensions to OSPF (MOSPF), Routing Information Protocol version 2 (RIPv2), Border Gateway Protocol (BGP), and Distance Vector Multicast Routing Protocol (DVMRP) are examples of protocols operating above a transport layer protocol.

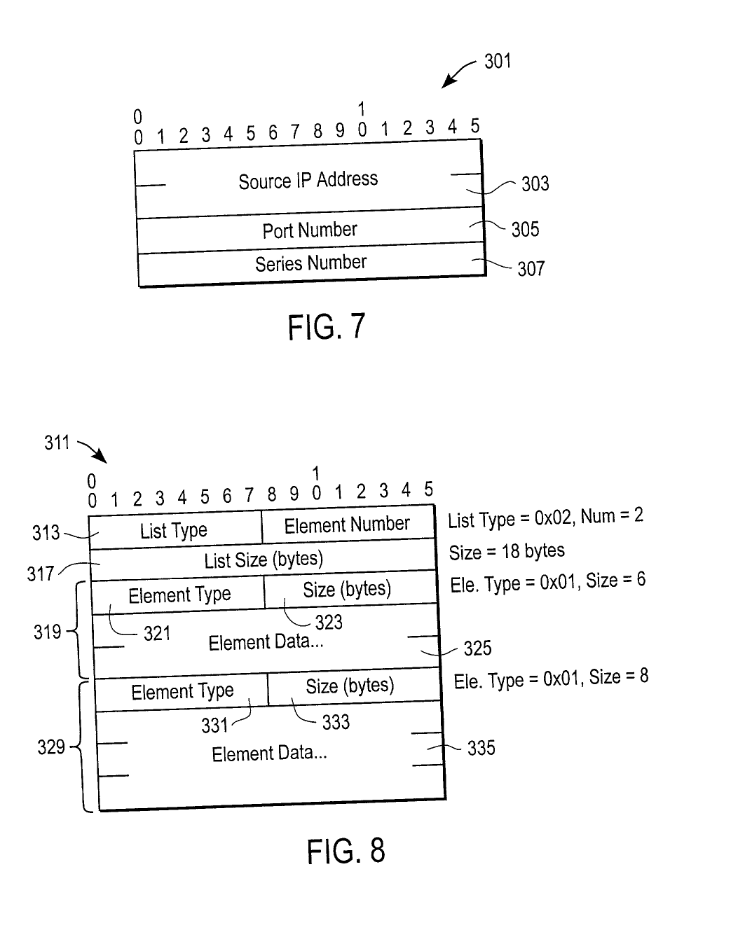

According to specific embodiments of the present invention, a characteristically routed packet (or “charcast packet”) contains at a minimum a globally unique identifier and characteristic-specific flags, which are in the charcast packet header. The globally unique identifier corresponds to a unique set of characteristics for a particular destination node or nodes. FIG. 7 illustrates the format of a characteristic packet's globally unique identifier 301, according to a specific embodiment. According to this specific embodiment, identifier 301 can be an 8 byte field that includes the sender's IP address 303 (4 bytes), the sender's port number 305 (2 bytes), and a message series number 307 (2 bytes). The sender IP address 303 and port number 305 identify a specific process and socket within a specific host, and the series number 307 identifies the different destinations targeted from that socket. As mentioned earlier, characteristics are used by the network for locating destination nodes and creating the initial routing tree. Characteristic-specific flags defined include a CHARCAST_TRAILBLAZER_PACKET flag that indicates whether a charcast packet is a trailblazing packet (as discussed below), a CHAR-CAST ORIGINAL_CHARACTERISTICS REQUEST flag that indicates whether a charcast packet is a CharARP query (as discussed above), and a CHARCAST_ORIGINAL_CHARACTERISTICS flag that indicates whether a charcast packet is a CharARP query response. According to a specific embodiment, the characteristic-specific flag can be a 1-byte field that can be set to indicate the different characteristic-specific flag types described above.

In some specific embodiments, every charcast packet includes the list of characteristics for the destination node, in addition to the unique identifier and characteristic-specific flags. However, due to the large overhead that may be needed to transmit the list of characteristics, only a “trailblazing packet” includes the list of characteristics, according to some preferred embodiments. When a sender transmits a packet to a new characteristic destination, the sending host detects the new destination, assigns the new destination a globally unique identifier, and then sends out a trailblazing packet. This trailblazing packet uses a normal characteristic header, which contains the unique identifier and characteristic routing specific flags, and additionally houses the original list of characteristics in the data payload section of the packet. For the preferred embodiments, immediately after a trailblazer packet has been sent, the original charcast packet that the sender transmitted and all subsequent packets are sent using the normal charcast header that only contains the unique identifier and flags but not the corresponding list of characteristics. The trailblazing packet has a CHARCAST_TRAILBLAZER_PACKET flag that is set. The trailblazer packet effectively creates the characteristic routing tree paths through the network, and sets in motion the chain of events resulting in an optimal routing tree for that characteristic destination and sender combination. At each router along the path from the sender to the set of receivers, the original characteristics are recorded as part of the characteristic forwarding cache entry created when the trailblazer packet arrives.

As discussed above, destination nodes for a charcast packet are those nodes having the list of characteristics corresponding to that packet's global unique identifier associated with that list. In a charcast packet, the characteristic destination (or list of characteristics) is represented as a list of elements, which can be strings of arbitrary size composed of unsigned bytes, in some embodiments. In other embodiments, the list of elements could have other lists as individual elements embedded inside of it.

In accordance with a specific embodiment of the invention, FIG. 8 shows the format of a characteristic destination (or list of characteristics) that includes two elements (characteristics) making up the characteristic destination of a charcast packet. As seen in FIG. 8, the characteristic list 311 includes fields in a particular predefined order: a list type field 313 (1 byte), an element number field 315 (1 byte), a list size field 317 (2 bytes), and two list elements 319 and 329. List type field 313 is set, for example, to a predetermined value such as 0×02 to indicate a list. Element number field 315 is set to the number of elements in the list (in this example, as element number field 315 is an 8-bit field, the list is limited to 256 total possible elements). List size field 317 indicates the total size in bytes of the entire encoded list including the list type field 313, the element number field 315, the list size field 317, and the elements 319 and 329 themselves (for example, in this example, the total list size would be 18 bytes). Each list element (319, 329 in this specific example) includes a 1-byte element type field (321, 331), a 1-byte size field (323, 333), and an element data field (325, 335). It is noted that the list elements contained in a list can be of different sizes. The element type field is set, for example, to another predetermined value such as 0×01 to indicate an element. The size field indicates the total size in bytes of the entire encoded element including the element type field, the size field and the element data field (in this example, the size field would indicate the value six for element 319 and the value eight for element 329). For an element, the element data field is the actual raw element data itself, and the size of the element data field is not a fixed size but rather will depend on the size of the element data (for example, as mentioned above, a particular element in an element list could have a list of elements embedded within that particular element). Of course, it is recognized that a characteristic destination can include an arbitrary number of elements for different charcast packets by having additional elements in the list.

Of the list of elements in a charcast packet, the first element of the list is assumed to be a command, in accordance to a specific embodiment. According to this specific embodiment, the following commands are recognized: AND—Destinations must match all of the elements in the list, where the list may contain an arbitrary number of elements; OR—Destinations must match at least one of the elements in the list, where the list may contain an arbitrary number of elements; Range—Destinations having all of the known characteristics that lie in the range between the first list element and the second list element, where the list must contain at least two elements after the range command; and Similar—Destinations must be similar to all of the elements in the list, where the list may contain an arbitrary number of elements and the first element after the command is the percentage of similarity (for example, 100% indicates an exact match and 0% indicates a complete opposite match). For backward compatibility purposes, the AND command is implied if no command is given as the first element in the list. The different commands have corresponding values that are indicated in the element type field of the each element that identifies the element as a particular command.

In accordance with this specific embodiment (and using exemplary characteristics as shown in Table 1 above), an example of a characteristic destination is: (AND ASIC Wavelet (RANGE Helium Hydrogen) RAM (RANGE DSP Flash)), where the ‘(‘and’)’ denote the beginning and end of a list. A characteristic packet that has this particular exemplary characteristic destination is intended to be received by nodes that have all the characteristics of (a) an ASIC, (b) a Wavelet, (c) Helium and Hydrogen, (d) RAM, and (e) DSP and Fast Fourier and Flash.

1. Implementations Below IP

The specific embodiments with characteristic routing residing below IP can provide a standard set of functionalities to IP. In particular, embodiments with characteristic routing residing below IP in the data link layer can allow characteristic routing to take advantage of the features (e.g., speed or functionality) of the particular data link layer protocol used. For example, a specific embodiment could interface with Ethernet hardware that is VIA capable and take advantage of the ability to asynchronously notify of the transmission or reception of data packets and its ability to employ direct memory access (DMA). However, as data link layer protocols do not typically provide packet fragmentation and reassembly where the data packet is larger than the maximum transport unit (MTU), these embodiments would need to implement their own fragmentation and assembly. In addition, these embodiments would need to have new interface code for characteristic routing implemented for each of the different data link layer protocols.

2. Implementations in the Network Layer

According to specific embodiments, the characteristic routing protocol can be ideally implemented in the network layer. For internetwork environments where a completely new network layer protocol can be used without concern for any existing network layer protocols, the characteristic routing protocol can be used as the network layer protocol in a specific embodiment.

Given the prevalence of the Internet Protocol (IP), an existing network layer protocol, in today's networks with IP having become a de facto application programming interface (API) for network protocols, compatibility and co-existence with IP would be desired by many. When compatibility with IP is desired, the characteristic routing protocol can be implemented in the network layer to co-exist with IP according to various specific embodiments. In one such embodiment, the characteristic routing protocol could be completely separate from IP and would require new data link encapsulations to distinguish it from the IP protocol IPv4. In another such embodiment, the characteristic routing protocol could be implemented as part of IP by existing as an option to the IP header and by adding fields for a set of characteristics and characteristic-routing-specific flags to a conventional network packet. Advantageously, this embodiment would advantageously allow packets routed using characteristic routing to take advantage of all the link layer protocols that IP runs over and allow transport layer protocols (such as User Datagram Protocol (UDP)) that run over IP to immediately take advantage of the added functionality provided by characteristic routing while keeping the amount of legacy applications re-coding to a minimum. However, this embodiment may not operate optimally in those networks utilizing certain commonly-used routers that ignore header options in order to forward packets faster. In yet another such embodiment, the characteristic routing protocol could be implemented as part of the IP protocol family that is co-resident with IP as a different version number of IP. This embodiment has the benefit of running over all of the link encapsulations of IP while still being a separate protocol, similar to IPv5 (also known as the ST2+ protocol, described by L. Delgrossi and L. Berger in “Internet Stream Protocol Version 2 (ST2) Protocol Specification—Version ST2+”, RFC 1819, August 1995). However, this type of embodiment may not operate in internetworks utilizing IPv4 implementations that do not check the version field in the packet headers and therefore become confused when receiving an IPv5 packet. Further, it may be difficult to obtain an IP Protocol Number officially, as these are drawn from an eight-bit range of numbers.

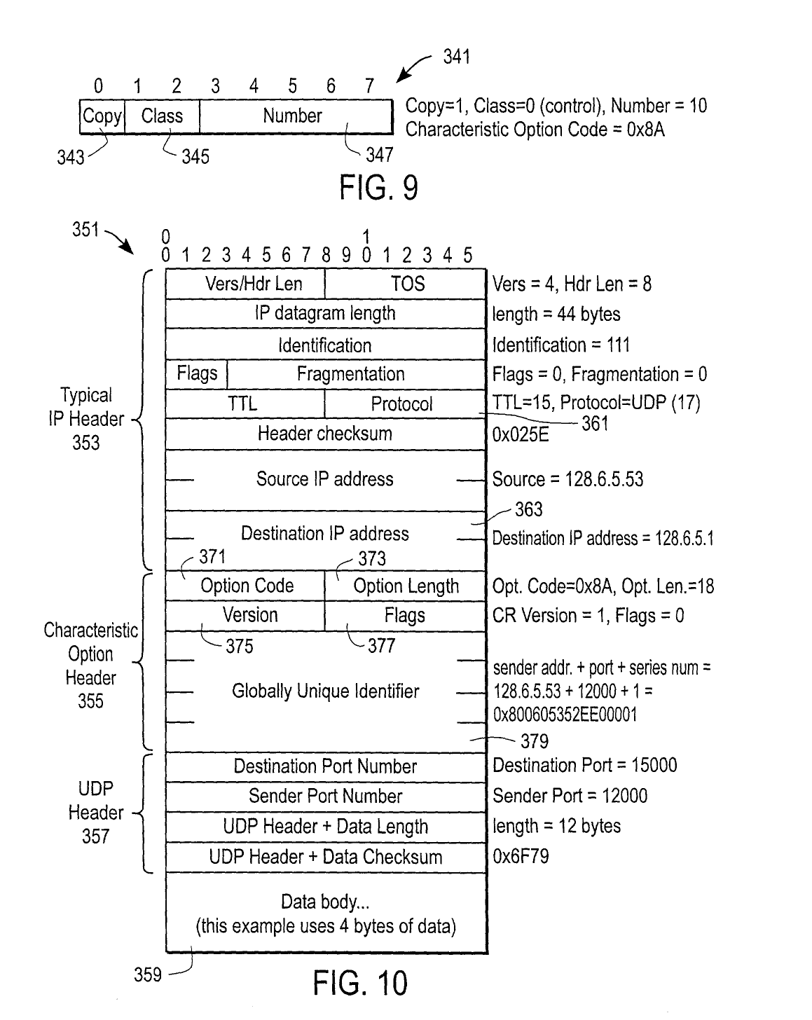

A specific embodiment where the characteristic routing protocol is implemented in the network layer as part of IP using IP header options is discussed herein as an example. Having a class and number, each defined IP header option indicates a different type of IP option. For example, currently defined IP header options exist for carrying authentication and group membership information (security option—class 0, number 2), for indicating routers the packet must pass through on the way to a destination (loose source routing—class 0, number 3), as well as other options not discussed herein. FIG. 9 shows a 1-byte option type field 341 that includes a copy flag 343, a class field 345 and a number field 347, in accordance with the specific embodiment. In the IP header option, copy flag 343 for the characteristic IP option is set to 1, so that all fragments or copies of the packet will include the characteristic header option information. The characteristic IP option, which defines the destination as a characteristic destination, has class flag 345 set to 0 because it controls how the packet is routed. Any unassigned IP header option number value, such as 10, may be used for number field 347 to define the new IP header option referred to as a characteristic IP option. Therefore, in a specific embodiment, the characteristic IP option has its copy flag set to 0, its class flag set to 0, and its number flag set to 10, resulting in a characteristic option code of 0×8A. In this specific embodiment, characteristic routing is indicated as a particular defined option to the IP header, as discussed above, and additional fields (for a version of characteristic routing, the globally unique identifier, a set of characteristics, and characteristic-routing-specific flags as discussed generally above) are added to the payload of a conventional IP network packet. Embodiments such as described in conjunction with FIG. 9 would advantageously allow packets routed using characteristic routing to take advantage of all the link layer protocols that IP runs over and allow transport layer protocols (such as UDP) that run over IP to immediately take advantage of the added functionality provided by characteristic routing while keeping the amount of legacy applications re-coding to a minimum. However, this embodiment may not operate optimally in those networks utilizing certain commonly used routers that ignore IP header options in order to forward packets faster. In order to operate optimally in networks utilizing such routers that ignore IP header options, a separate characteristic option header is used in addition to the typical IP header. The packet header 351 seen in FIG. 10 illustrates an example of this specific embodiment of the invention with a characteristic routing option extension to a typical IP header. In particular, the packet header 351 includes a typical IP header 353, a characteristic option header 355, and a UDP header 357. Following UDP header 357 is a data payload field 359 that contains packet data, and other fields (not shown) that conventionally follow the payload. The IP header followed by the characteristic routing option extension effectively makes the packet a UDP datagram with a characteristic destination. The protocol number field 361 in IP header 353 indicates the type of header that follows IP header 353. For example, the UDP protocol number (17) would be used to indicate the presence of the UDP header 357 immediately following IP header 353. In the present embodiment, a predefined characteristic routing protocol number that is currently an unassigned IP protocol number (such as 254 in this example) can be used to indicate the presence of a characteristic option header 355 following IP header 353. Accordingly, a characteristic router, upon receiving a packet with the protocol field 361 of IP header 353 set to the defined characteristic routing protocol number, passes the packet to characteristic routing-specific code within the router so that the packet is forwarded according to characteristic criteria and not IP criteria. Since characteristic routers may be spread throughout a network with only regular IP routers in between, each characteristic router will place the IP address of the next-hop characteristic router in the destination IP address field 363 of IP header 353.

In the example shown in FIG. 10, a trailblazing packet has already been sent and the globally unique identifier is set to a particular value like 0×8006053 52EE00001 (made from 128.6.5.53+12000+1), as the packet being sent from IP address 128.6.5.53 and port number 12000 and the destination port number is 15000. As seen in FIG. 10, characteristic option header 355 includes an option code field 371, an option length field 373, a characteristic header version field 375, a characteristic-specific header flag field 377, and a globally unique identifier field 379. Option code field 371 is set to 0×8A, as discussed already in the context of FIG. 9. Option length field 373 is set to the value (in this example, 18) in bytes of the total length of characteristic option header 355 and the packet data (in this specific example, 6 bytes of data) in the data field 359. Characteristic header version field 375 is set to the particular version number of the characteristic routing protocol used (in this example, the version is 1). Characteristic-specific header flag field 377 can be set to predefined values indicating CHARCAST_TRAILBLAZER_PACKET, CHARCAST_ORIGINAL_CHARACTERISTICS_REQUEST, or CHARCAST_ORIGINAL_CHARACTERISTICS, as was discussed generally above. Globally unique identifier field 379 includes the sender IP address, port and series numbers, as already described generally above in conjunction with FIG. 7.

3. Implementations above IP in the Transport Layer

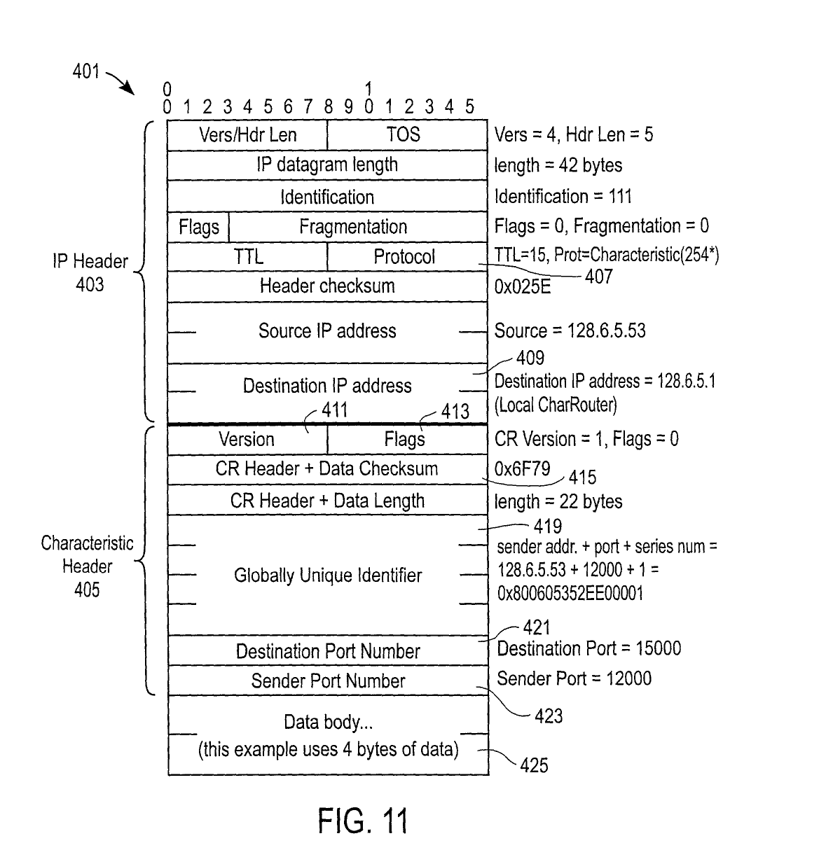

In accordance with another specific embodiment, FIG. 11 shows an example of a characteristic routing packet that uses a characteristic header immediately after the IP header. In particular, the packet header 401 includes a typical IP header 403 and a characteristic header 405. According to this embodiment, the protocol number field 407 in IP header 403 indicates the type of header that follows IP header 403. In the present embodiment, a predefined characteristic routing protocol number that is currently an unassigned IP protocol number (such as 254 in this example) can be used to indicate the presence of characteristic header 405 following IP header 403. Accordingly, a characteristic router, upon receiving a packet with the protocol field 407 of IP header 403 set to the defined characteristic routing protocol number, passes the packet to characteristic routing-specific code within the router so that the packet is forwarded according to characteristic criteria and not IP criteria. Since characteristic routers may be spread throughout a network with only regular IP routers in between, each characteristic router will place the IP address of the next-hop characteristic router in the destination IP address field 409 of IP header 403.

In the example shown in FIG. 11, a trailblazing packet has already been sent and the globally unique identifier is set to 0×800605352EE00001 (made from 128.6.5.53+12000+1), as the packet being sent from IP address 128.6.5.53 and port number 12000 and the destination port number is 15000. As seen in FIG. 11, characteristic header 405 includes a characteristic header version field 411, a characteristic-specific header flag field 413, a characteristic header-and-data checksum field 415, a characteristic header-and-data length field 417, a globally unique identifier field 419, a destination port number field 421, and a sender port number field 423. Following characteristic header 405 is a data field 425. Characteristic header version field 411 is set to the particular version number of the characteristic routing protocol used (in this example, the version is 1). Characteristic-specific header flag field 413 can be set to predefined values indicating CHARCAST_TRAILBLAZER_PACKET, CHARCAST_ORIGINAL_CHARACTERISTICS_REQUEST, or CHARCAST_ORIGINAL_CHARACTERISTICS, as was discussed generally above. Characteristic routing header-and-data checksum field 415 contains the checksum value that verifies that the characteristic header and data have arrived without errors. Each router along the path from sender to the set of receivers needs to verify this checksum. Characteristic routing header-and-data length field 417 is set to the value (in this example, 22) in bytes of the total length of the characteristic header 405 and data (in this specific example, 4 bytes of data) in the data field 425. Globally unique identifier field 419 includes the sender IP address, port and series numbers, as already described generally above in conjunction with FIG. 7. Destination port number field 421 contains the IP port number to which the packet is being sent, and the sender port number field 423 contains the IP port number of the sender. If the application which sent the packet does not have a port number associated with it destination due to the sender's socket not having been bound to a particular Internet name space, then the value of the sender port number field 423 will be zero.

Although the various specific embodiments with implementations in the network layer or in the data link layer discussed above may be used, the specific embodiments with characteristic routing residing above IP in the transport layer (such as discussed in conjunction with FIG. 11) are preferred in situations where the present invention is desired to make use of the functionality of IP. As IP already runs over many data link layer protocols, these specific embodiments running over IP advantageously can automatically leverage the large installed base of functionality and can take advantage of IP's network layer services (such as using IP's packet fragmentation and reassembly without regard to any data link layer MTU).

Several protocols, such as OSPFv2, RIPv2, and DVMRP, already exist for discovering network topology and automatically configuring a routing table, and the present invention provides for augmentation of these types of protocols to accommodate characteristic routing information in accordance with specific embodiments. The network stack locations of some of these types of embodiments, such as CharOSPF, CharRIP and CharBP (each will be described further below), are shown in FIG. 12. These specific embodiments using CharOSPF, CharRIP and CharBP can use the characteristic header format as discussed in FIG. 11. CharOSPF is a characteristic routing protocol extension of OSPFv2, in accordance with a specific embodiment. CharRIP is a characteristic routing protocol extension of RIPv2 that does not change RIP's specification but merely augments it, in accordance with another specific embodiment. CharBP is a characteristic routing protocol modification of DVMRP, in accordance with yet another specific embodiment. CharOSPF is a shortest path approach to routing, and CharRIP and CharBP are both distance vector approaches to routing. For simplicity, details of CharOSPF CharRIP and CharBP will be described below as representative specific embodiments. However, it should be noted that similar characteristic routing extensions to other existing network topology configuration protocols, such as BGP, IGRP, PIM or CBT, are also possible. Another protocol described by J. J. Garcia-Luna-Aceves and S.Murthy in “A Path Finding Algorithm for Loop-Free Routing” (IEEE/ACM Trans. Networking, February 1997) is a path finding approach to routing.

In terms of the amount of information needed to perform loop-free routing, the link-state shortest path approaches (like CharOSPF) require the most information, the distance vector approaches (like CharRIP and CharBP) require the least information, and the path finding approaches require an amount of information between that required by the shortest path and distance vector approaches. The amount of information gathered before packet forwarding can commence in these extended protocols (CharOSPF, CharRIP and CharBP), has a direct influence on the number of prune messages that subsequently have to be sent and processed in order to clean-up the routing tree that results from forwarding the first charcast message. In particular, CharOSPF has complete knowledge of network topology in its network database and is able to leverage this database to create prune-free routing trees. CharRIP has incomplete knowledge of the network and only knows the shortest number of hops to each destination, resulting in routing trees that need to be pruned. CharBP only uses a routing table to ensure that a packet arrives on the shortest path from the sender and uses a broadcast-and-prune to forward the packet. CharOSPF, CharRIP and CharBP each form source-based charcast routing trees, with CharOSPF and CharRIP broadcasting the characteristic reach information of all their networks, and CharBP employing a simple broadcast-and-prune approach. CharOSPF, CharRIP and CharBP are data-driven protocols so all routing decisions are made when the first data packet from a particular sender and for a particular characteristic destination is seen.

CharOSPF, CharRIP and CharBP are used as examples of characteristic routing extensions to existing network topology configuration protocols, because they offer a contract in the amount of information that has to be gathered and stored in a routing database before packet forwarded can be performed. CharOSPF, CharRIP and CharBP and other specific embodiments with characteristic routing running over a transport layer protocol also are able to leverage additional services. For example, embodiments running over UDP or TCP can use the optional checksum to validate the correctness of the received protocol packets. Embodiments running over UDP or TCP also can run in the user space without special privileges (in contrast, embodiments running directly over IP would have to use raw sockets requiring super-user permissions in order to use). Specific embodiments running over UDP or TCP further can more easily use port numbers (which are drawn from a sixteen-bit range of numbers) to distinguish between protocols or between components of a protocol. Moreover, embodiments running over TCP have a guarantee of reliable delivery of all protocol information. With regard to the representative specific embodiments, CharRIP runs over UDP, CharBP runs over IP, and CharOSPF runs over IP.

a. CharOSPF

CharOSPF, running over a transport layer protocol, is a characteristic routing protocol extension of OSPFv2, in accordance with a specific embodiment.

A shortest path approach protocol, Open Shortest Path First protocol (OSPF such as described by J.Moy in RFC 2328 mentioned above) is an Internal Gateway Protocol (IGP) meant for routing among routers within an IP autonomous system. An autonomous system can range in size from a small company network to a university-wide campus network. Protocols using the shortest path approach, such as OSPF, can be augmented in a specific embodiment by following the methodology described by J. T. Moy in OSPF: Anatomy of an Internet Routing Protocol (Addison Wesley Publishing Co., January 1998). OSPF is a dynamic link-state routing protocol that uses link state advertisements to pass information about network topology based on unicast and/or multicast routing. As a dynamic protocol, OSPF quickly detects changes in the status of connected subnets and then advertises those changes throughout the autonomous system by flooding it with link state advertisements. In OSPF, each router has the responsibility of advertising the status of the subnets to which it is directly attached and of forwarding the advertisements to other routers. As part of the protocol, each router maintains a database describing the topology of the entire autonomous system. Since this database describes all of the nodes and links within the autonomous system, it is called a link-state database. After all routers have flooded their incident subnet status, all routers will have the same link-state database. Each router then executes Dijkstra's shortest-path-first (SPF) algorithm on the link-state database in order to calculate a tree of loop-free shortest paths with itself as the root and every destination in the autonomous system as a leaf. For purposes of calculating the shortest-paths, each link is assigned a single dimensionless metric by the router that advertised it. If more than one equal-cost unicast path exists to a destination, then IP traffic is distributed equally among them. Whenever a router receives a flooded subnet status change, such as a link going down, it will rerun Dijkstra's algorithm and recalculate the shortest-paths tree.

OSPF allows a two-level hierarchical routing scheme to be defined within an autonomous system in order to be able to build large networks. Contiguous subnets can be clustered together into groupings called areas. The boundary between two areas is the router that they have in common. This allows that each subnet to be entirely contained within a single area. Within an area, normal OSPF routing as described above occurs. However, addressing information is aggregated when advertised across area boundaries, and therefore the detailed topology information of the area is hidden from the rest of the autonomous system. Two advantages are derived from this information hiding. First, the size of the routing tables throughout the autonomous system is reduced. Second, topology changes within an area are also hidden from the rest of the autonomous system, and hence the routing traffic needed to maintain the routing tables is also minimized.

In accordance with a specific embodiment using CharOSPF, new link state advertisements related to characteristic routing that reference pre-existing link state advertisements used for unicast and multicast routing can be used in addition to these pre-existing link state advertisements, and the characteristics information can thus be added to existing unicast/multicast entries in the routing table.

CharOSPF is a data-driven and source-based routing protocol that extends OSPF in two ways, in accordance with a specific embodiment.

First, CharOSPF extends OSPF's hierarchical inter-area abstraction. When advertising aggregate information between areas, the advertising router advertises a summary of the union of the characteristics of the subnets within the CharOSPF area. This characteristic summary of the CharOSPF area is then forwarded from area to area and advertised within the areas. Accordingly, individual routers within a CharOSPF area will know about the characteristic reach of the other areas and the appropriate border router to use when charcasting to the characteristic areas covered by those CharOSPF areas. CharOSPF thus takes advantage of the known hierarchical aspects of OSPF.

Second, CharOSPF enriches the network description contained in the link-state database by adding a new Link-State Advertisement (LSA), called the Characteristic-Area-LSA. Used in addition to the other LSAs in OSPF, the Characteristic-Area-LSA describes the characteristic reach of a network attached to the router originating this Characteristic-Area-LSA, which augments rather than replaces the OSPF Router-LSA. The Characteristic-Area-LSA is flooded throughout the autonomous system in the same manner as other LSAs. Having only area flooding scope, Characteristic-Area-LSAs distribute characteristic network information throughout a single area only. The Characteristic-Area-LSA uses 9 as the LSA type number for identification.

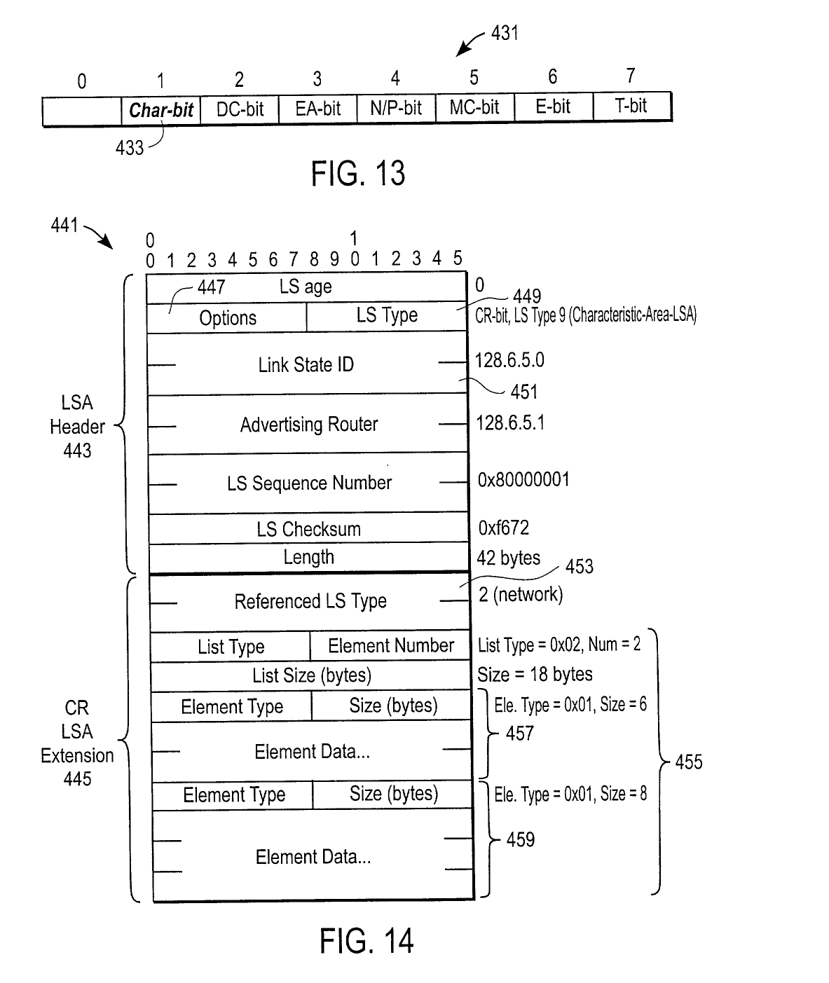

CharOSPF integrates a new Char-bit flag into the 8-bit OSPF Options field, which allows extensions to OSPF and backward-compatibility. The OSPF Options field, with each extension to OSPF being allocated a bit within the field, allows routers to discover which other routers support a particular protocol extension within the autonomous system or area. The OSPF Options field is included in all OSPF Hello packets, OSPF Data Description packets and OSPF LSAs. FIG. 13 illustrates the CharOSPF Options field 431 according to a specific embodiment. By setting the Char-bit flag 433 in CharOSPF Options field 431, routers are able to advertise to other routers that they are characteristically aware. Other bits in CharOSPF Options field 431 can be set to indicate other protocol extensions, such as the demand circuit extension (DC-bit), TOS-based routing extension (T-bit), multicast routing extension (MC-bit), and others. According to the specific embodiment, a router using an OSPF-derived protocol such as CharOSPF does not flood the LSA of a new extension (such as characteristic routing extension) to any neighboring routers unless a neighboring router also declares it supports that extension, and a router only stores and forwards the LSA extensions it understands.

In accordance with the specific embodiment, FIG. 14 illustrates an example of a Characteristic-Area-LSA packet 441 used in CharOSPF. Characteristic-Area-LSA packet 441 includes a LSA header 443 and a Characteristic Routing LSA extension 445. As mentioned earlier, the Characteristic-Area-LSA augments the Router-LSA information (subnet's IP address, mask, and metric) by carrying the characteristic information for the subnet and by referring to the previously transmitted Router-LSA that described that subnet. LSA header 443 is the standard LSA header used in OSPF with the following exceptions: the options field 447 (as described generally in conjunction with FIG. 13) has the Char-bit set to indicate the router is a characteristic router; the LS type field 449 is set to the CharOSPF-Area-LSA type number 9; and the link state ID field 451 is set to the link state ID of the Router-LSA to which this Characteristic-Area-LSA is referring. Characteristic Routing LSA extension 445 includes a referenced LS (link state) type field 453 and the subnet's characteristics encoded as a single list 455 (as described generally above in conjunction with FIG. 8). The referenced LS type field 453 contains the link state type of the referenced link state ID in field 451 of LSA header 443. This link state type information is used to help in matching the correct link state ID in the case where more than one entry has the same link state ID. In this specific example, the characteristics list 455 includes two elements 457 and 459, but different numbers of elements may exist in a list in other examples. The example of FIG. 14 is a Characteristic-Area-LSA that refers to a previously flooded Router-LSA that described the subnet 128.6.5.0/24, so the link state ID is set to 128.6.5.0 and the referenced LS type field is set to 2 to indicate that it is a network type.

b. CharRIP

As mentioned above, CharRIP, running over a transport layer protocol, is a characteristic routing protocol extension of RIPv2 that does not change RIP's specification but merely augments it, in accordance with a specific embodiment.

RIPv2 (such as described by G. Malkin in RFC 2453 entitled “RIP Version 2” (November 1998)) is an Internal Gateway Protocol (IGP) meant for routing IP packets among the routers and networks within an autonomous system. One of the earliest routing protocols used in the Internet, RIP is still in wide use today. Whereas newer IGPs are more powerful, RIP still has advantages that make it a viable alternative. Because of its relative simplicity, RIP is able to keep overhead (in terms of the bandwidth used), configuration, and management to a minimum. Also, because its description is one-fifth the size of the newer IGPs, it is much easier to implement and its code has a smaller footprint. However, RIP is restricted for use in an autonomous system that is, at most, of moderate size and is not optimal for use in a large-scale autonomous system. RIP is a dynamic Distance Vector protocol based on the Bellman-Ford algorithm (also known as the Ford and Fulkerson algorithm) derived from Bellman's equation.

When using RIP, routers build-up their knowledge of the network by exchanging their routing table information with their neighbors. The routing table information consists of a list of all of the known destinations, a metric in the form of the number of router hops that a packet must travel to reach a particular destination, and the neighbor router that is the next hop on the path to that destination. Routers periodically exchange their routing table information by first incrementing by one the metrics of all of the destinations and then advertising the entire table by broadcasting it. Routers can also explicitly request from each other the routing table entries for specific destinations. When a router receives a routing table advertisement from a neighbor router, it will compare the metric contained in the advertisement for each destination against the metric contained in its routing table. If the advertised metric is less, then the router will insert the metric for that destination in its routing table and change the next-hop router for that destination to be the router who sent the advertisement.

Parts of the network can become inaccessible due to a problem in the first version of RIP (RIPv1) called “counting to infinity.” This is caused by routing loops occurring when links fail. Two methods were introduced in the second version of RIP (RIPv2) to combat this problem: split horizon with poisoned reverse and triggered updates. Split horizon with poisoned reverse will prevent any routing loops that involve only two routers by requiring a router A change its routing table advertisements to a neighbor router B by setting to infinity the metrics of the routes that were learned from B. However, since it is still possible to fall into a routing loop (e.g., loops of three routers or more are still possible), triggered updates attempt to speed-up the convergence of the loop by requiring that routers immediately send update messages when a metric for a route changes.

CharRIP does not change the current RIP protocol specifications but rather augments it similarly to the way that authentication was added to RIP. In particular, CharRIP spreads characteristic routing table information around the network by adding a Characteristic Information Route Entry to the list of possible route entries. In accordance with a specific embodiment, a Characteristic Information Route Entry is identified by using a predefined hex value (such as 0×FFFE) in the Address Family field of a conventional RIP route entry. Table 2 below shows a list of the possible Address Family field values for CharRIP, according to this specific embodiment. A Characteristic Information Route Entry uses the space of an entire conventional RIP route entry, because RIP does not indicate the number of route entries in a routing table update. A router that receives a routing table update calculates the number of route entries by dividing the size of the update by the size of a route entry.

TABLE 2
CharRIP Address Family Identifiers.

| Address Family Name | Hexacode Value |
|---|---|
| Request whole routing table | 0x0000 |
| Internet Protocol | 0x0002 |
| Characteristic Information | 0xFFFE |
| Authentication | 0xFFFF |

A RIPv1 or RIPv2 router would ignore the Characteristic Information Route Entry value in the Address Family field, because it would not be identified as either an IP address family route entry or as an authentication route entry. In the specific embodiment, CharRIP routing table updates are marked as RIP version three (RIPv3) due to the manner in which RIPv1 and RIPv2 handle routing table update messages of higher versions. In particular, a RIPv1 or RIPv2 router discards all messages of version zero, discards messages of version one if any Must Be Zero (MBZ) field is non-zero, and does not discard messages of any version greater than one simply because an MBZ filed contains a non-zero value. Accordingly, with CharRIP indicated as RIPv3, CharRIP can be completely backward compatible with previous RIP versions, as long as the previous RIP versions maintain this behavior. If a CharRIP router receives a RIPv 1 or a RIPv2 routing table entry request, that router responds with a routing table advertisement of the appropriate version.

Due to the space limitations of a RIP route entry, a Characteristic Information Route Entry does not hold all the information about a particular destination. Rather, the Characteristic Information Route Entry augments the information about a particular destination that was previously advertised. According to the specific embodiment, a CharRIP routing table advertisement packet or response packet contains at least three distinct parts: the standard RIP header with the version number set to three, indicating that the packet contains a CharRIP packet; a normal RIPv2 route entry for a particular destination; and the Characteristic Information Route Entries that contain the characteristics of the particular destination described by that normal RIPv2 route entry. If all of the characteristics of a network will likely not fit in a single Characteristic Information Route Entry, then the characteristics are encoded as a single list and this encoding is treated as a single string of characteristics that is divided among several route entries. These Characteristic Information Route Entries are then placed in the CharRIP packet in sequential order, and the information in these route entries is joined together at the receiving end to recreate the original encoding of the list of characteristics. Therefore, a first Characteristic Information Route Entry in a CharRIP packet would include the characteristic address family identifier (as per Table 2), the referenced IP address, and the first part of the encoded list of characteristics. All subsequent Characteristic Information Route Entries in the same CharRIP packet would contain the characteristic address family identifier and the subsequent section of the encoded list of characteristics.

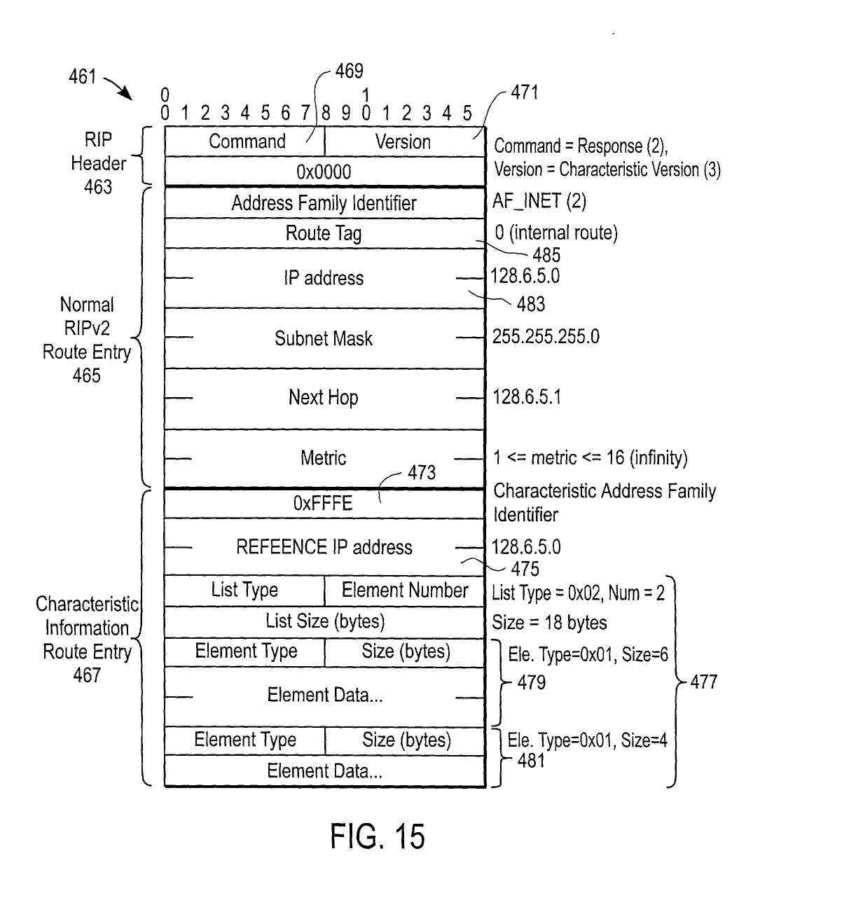

In accordance with this specific embodiment, FIG. 15 shows as an example a CharRIP packet 461. CharRIP packet 461 includes a RIP header 463, a normal RIPv2 Route Entry 465, and a Characteristic Information Route Entry 467. More specifically, FIG. 15 shows a CharRIP Response packet to a neighbor router's previous request for the routing table entry for IP address 128.6.5.0. Because it is a response packet, the command field 469 of RIP header 463 is set to two (indicating a response message). The version field 471 of RIP header 463 is set to three, indicating that this is a CharRIP packet. The RIPv2 part 465 of the packet 461 contains the normal route entry information for this destination. The Characteristic Information Route Entry 467 that follows it includes an address field 473, a reference IP address field 475, and a list 477 of characteristics. As discussed above, address field 473 is set to 0×FFFE to identify that characteristic information is contained. Reference IP address field 475 includes the same IP address in IP address field 483 of the RIPv2 route entry 465 referenced. The route tag field 485 of RIPv2 route entry 465 is set to zero to indicate that this is an internal route.

In this example, the list 477 of characteristics in characteristic information route entry 467 includes two characteristics, encoded as elements 479 and 481. Of course, a different number of characteristics may be in the list in other examples.

c. CharBP

In accordance with yet another specific embodiment, CharBP is a characteristic routing protocol modification of DVMRP (such as described by Waitzman, D. C. Partridge, and S. Deering in “Distance Vector Multicast Routing Protocol” RFC 1075, November 1988). CharBP is a broadcast-and-prune protocol that utilizes distance vector technology to spread knowledge of the shortest distance in router hops to all of the potential packet sources. In this manner, CharBP is similar to a reverse-RIP in the way that it operates. Each CharBP router periodically broadcasts to its neighbors the list of known sources and the router's distance (in router hops) to each source. Each CharBP router then determines the previous hop for the path to each source by choosing the neighbor router that advertises the shortest distance from the source. CharBP has the same convergence problems that RIP and other distance vector protocols have and attempts to ameliorate them by using the methods of split horizon with poison reverse and hold down.

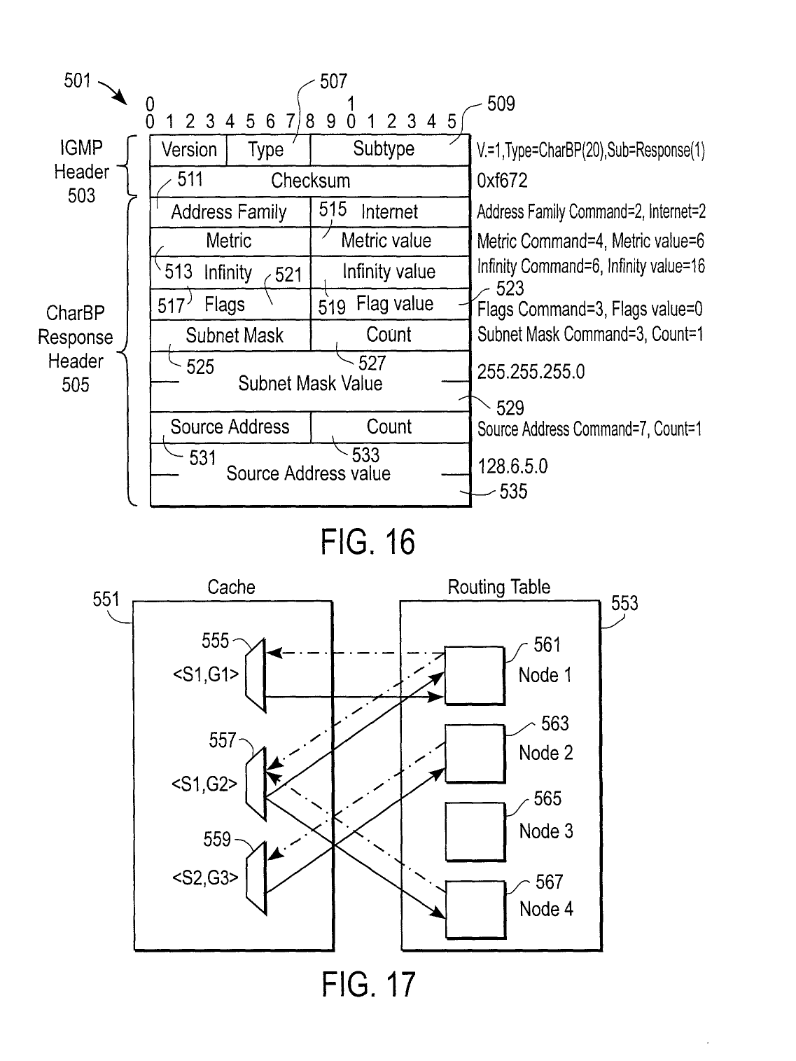

In accordance with the specific embodiment, FIG. 16 shows as an example a CharBP packet 501. In this embodiment, CharBP is encapsulated by IGMP and CharBP packet 501 includes an IGMP header 503 and a CharBP header 505. IGMP header 503 includes a type field 507 and a subtype field 509. CharBP packets are encoded as a predefined IGMP type that is currently unassigned. For example, a CharBP packet could use IGMP Type 0×20 in type field 507. Subtype field 509 indicates the CharBP packet type (e.g., a CharBP probe packet that probes for CharBP routers, a CharBP route report packet that requests a route report, a CharBP response packet that is a response to a probe or route report packet, or a CharBP prune packet that indicates a prune should be performed). More specifically, FIG. 16 shows a CharBP Response packet to a neighbor router's previous request for the source table entry for IP address 128.6.5.0. Because it is a response packet, subtype field 509 of IGMP header 503 is set to one (indicating a response message). Since CharBP is a modified version of DVMRP, CharBP uses a subset of the DVMRP routing control message commands. The subset of DVMRP commands used by CharBP is shown in Table 3. CharBP header 505 includes the information needed to define a route: the metric (a metric command field 513 and a metric value field 515), the infinity value (an infinity command field 517 and an infinity value field 519), the flags (a flags command field 521 and a flags value field 523), the subnet mask (a subnet mask command field 525, count field 527 and subnet mask value field 529), and the source address (a source address command field 531, count field 533 and source address value field 535). Version field 471 of RIP header 463 is set to three, indicating that this is a CharRIP packet. The RIPv2 part 465 of the packet 461 contains the normal route entry information for this destination. The Characteristic Information Route Entry 467 that follows it includes an address field 473, a reference IP address field 475, and a list 477 of characteristics. As discussed above, address field 473 is set to 0×FFFE to identify that characteristic information is contained. Reference IP address field 475 includes the same IP address in IP address field 483 of the RIPv2 route entry 465 referenced. The route tag field 485 of RIPv2 route entry 465 is set to zero to indicate that this is an internal route. In this example, the list 477 of characteristics in characteristic information route entry 467 includes two characteristics, encoded as elements 479 and 481. Of course, a different number of characteristics may be in the list in other examples.

TABLE 3
The CharBP routing control message commands.

| Number | Command Name | Description |
|---|---|---|
| 0 | Null | No operation command. |
| 2 | Address Family | Specifies the socket address family to use for |
| | | all subsequent destination addresses. Only |
| | | the Internet address family is currently |
| | | recognized. |
| 3 | Subnet Mask | Specifies the subnet mask(s) to use for all |
| | | successive destination addresses. |
| 4 | Metric | Specifies the metric in terms of router hops. |
| 5 | Flags | Allows richer information in the form of bit |
| | | flags, such as the host unreachable flag or |
| | | the split infinity flag. |
| 6 | Infinity | Specifies the value of infinity to use for the |
| | | router hop count. |
| 7 | Source Address | Specifies a list of one or more IP addresses |
| | | for source subnets. |
| 8 | Request Source | Allows a CharBP router to request the metric |
| | Address | information for a list of one or more subnet |
| | | IP addresses. |

D. Characteristic Routing Forwarding Cache and Routing Trees

Using an augmented protocol such as CharOSPF, CharRIP or CharBP for discovering the network topology and automatically configuring a routing table, a characteristic router thus will have a routing table entry based on characteristics for each destination in the network.

In order to reduce the forwarding cost, the characteristic router keeps a cache of the next-hop destinations of the most recent characteristic message packets. There is a separate cache entry for each <sender address, destination characteristics> combination. Typically, the first packet for a <sender address, destination characteristics> combination that a CharRouter sees is the trailblazing packet, which then causes a cache entry to be created and populated. When a characteristic router receives a characteristic message packet, it will use the incoming packet's sender IP address and destination characteristics together as a key into the cache. If this is not the first packet to arrive for this destination and if the timer on the cache entry has not yet expired, then the cache will return a list of all of the neighbor routers to which copies of the packet must be sent.

According to a specific embodiment, each forwarding cache entry for a <sender address, destination characteristics> combination that is kept by a characteristic router contains an EXACT_CHARACTERISTIC_FLAG indicating whether the cache item contains the original characteristics of the destination, and a copy of the characteristic message's original destination characteristics. The copy of the original destination characteristics is taken from the first trailblazing packet that created the routing tree and cache entries in the routers along the routing tree paths. Each cache entry also includes information about the upstream router for this characteristic message and about the sender of the characteristic message. In particular, the cache entry includes the IP addresses of the upstream router and of the sender. The cache entry also includes a RECALCULATE_ENTRY_FLAG indicating whether the cache entry should be deleted and recalculated when the next characteristic packet bound for the same <sender address, destination characteristics> combination arrives. Each cache entry includes a time stamp indicating when the cache entry was last updated or refreshed. A cache entry is refreshed every time another packet with the same <sender address, destination characteristics> combination is forwarded through the characteristic router. Each cache entry also has a list of the next-hop downstream characteristic routers that should receive a copy of all characteristic packets having the same <sender address, destination characteristics> combination. Each cache entry can have an ORIGINATING_HOST_FLAG set if that cache entry is located on the sending host. Having this flag set causes the first packet to automatically generate and transmit a trailblazing packet and also causes the cache entry to stay resident until the associated socket is deleted. Finally, each cache entry additionally includes a list of pointers to each of the routing table entries that describe the set of destinations for this cache entry's characteristic destination.

FIG. 17 is an exemplary diagram illustrating pointer links between cache entries in a characteristic router's forwarding cache and the entries in the characteristic router's routing table, in accordance with a specific embodiment In the example shown for FIG. 17, the characteristic router includes cache 551 and routing table 553. In cache 551, there are multiple unique characteristic message cache entries (one entry for each <sender address, destination characteristics> combination, with abbreviation <S, G> where S indicates sender and G indicates a characteristic destination). In this example, cache 551 includes a cache entry 555 for the <S1, G1> combination, a cache entry 557 for the <S1, G2> combination, and cache entry 559 for the <S2, G3> combination. Routing table 553 includes multiple networking node routing table entries. In this example, routing table 553 includes a routing table entry 561 for node 1, a routing table entry 563 for node 2, a routing table entry 565 for node 3, and a routing table entry 567 for node 4. Each cache entry has a list of pointers (indicated by solid line arrows) to each of the routing table entries that describe the set of destinations for that cache entry's destination characteristics; conversely, each routing table entry has a list of pointers (indicated by dotted-dash line arrows) to the cache entries that refer to that routing table entry. As seen in the example of FIG. 17, cache entry 555 has a pointer to routing table entry 561, because node 1 is the only member of the set of destinations for the characteristic message <S1, G1>; cache entry 557 has pointers to routing table entries 561 and 567, because both nodes 1 and 4 are part of the set of destinations for the characteristic message <S1, G2>; and cache entry 559 has a pointer to routing table entry 563, because node 2 is the only member of the set of destinations for the characteristic message <S2, G3>. In routing table 553, routing table entry 561 has pointers to cache entry 555 and 557 for characteristic messages <S1, G1> and <S1, G2> because both of these cache entries include node 1 in their set of destinations and refer to node 1; routing table entry 563 has a pointer to cache entry 559 for characteristic messages <S2, G3> because this cache entry includes node 2 in its set of destinations and refers to node 2; routing table entry 565 has no pointers any cache entries because none of the cache entries includes node 3 in their set of destinations; and routing table entry 567 has a pointer to cache entry 557 for characteristic messages <S1, G2> because this cache entry includes node 4 in its set of destinations and refers to node 4.

Each characteristic router maintains its forwarding cache. As mentioned above, typically, the first packet for a <sender, destination characteristics> combination that a characteristic router sees is the trailblazing packet, which causes a cache entry to be created and populated. Cache entries are soft state and remain in existence as long as they are refreshed periodically. Every time a new packet for a <sender, destination characteristics> combination arrives at the characteristic router, the cache entry for that combination is referenced and its timestamp updated. If no new packets are seen for a predetermined time period (for example, 30 seconds), then that cache entry's information is considered stale and is deleted. If the cache entry is still in existence and a new trailblazing packet arrives for that <sender, destination characteristics> combination, then the original cache entry is deleted and a new cache entry is created and populated.

On the arrival at a characteristic router of a characteristic routing protocol control message announcing a change in the network topology that affects a specific subset of the destinations listed in the routing table, the characteristic router's forwarding cache also needs to be updated. However, because of the high cost involved in recalculating a characteristic set of destinations based on the new network topology, it is both desirable to make changes only to those cache entries that are affected and not desirable to recalculate the paths for all of the affected cache entries all at once. This is especially so, because some of the cache entries may not be used again because no additional packets for that <sender, destination characteristics> combination may arrive. Since the characteristic router does not know which of the cache entries are simply waiting to time out and which are being actively used, the characteristic router simply marks all of the affected cache entries by setting their RECALCULATE_ENTRY_FLAG. The affected cache entries are found by following the pointers to them from the routing table entries whose information is changed by the incoming routing protocol control message. By setting the cache entry's RECALCULATE_ENTRY_FLAG, the characteristic router indicates that the cache information needs to be rebuilt when the next packet for that <sender, destination characteristics> combination arrives. If no such packet arrives, then the cache entry will time out as normal and be deleted. If a new packet does arrive, however, then not only does it trigger a recalculation of the routing cache entry information, but it also causes the characteristic router to issue a new trailblazing packet for that <sender, destination characteristics> combination. In this manner, the stored original characteristic destination's characteristics information can be used for the new trailblazing packet. The new trailblazing packet forces all downstream routers also to recalculate their cache entries, even though they may not have received yet any routing protocol control message indicating the network topology change. After the new trailblazing packet is sent, then the characteristic packet is sent immediately after it. This scheme, according to a specific embodiment, effectively spreads out the recalculations of the cache entries over time and perturbs the characteristic router less.

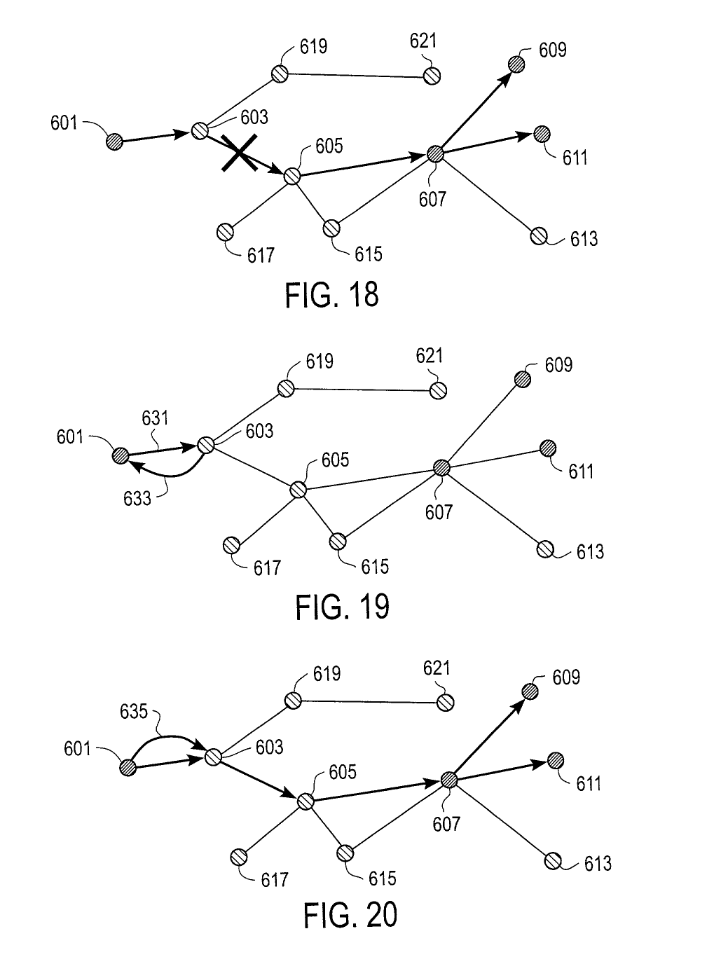

If the first trailblazing packet never arrives or if a cache entry times out just before another characteristic packet arrives at the characteristic router (since the trailblazing packet may be dropped along a route due to network congestion or errors), the routing tree unintentionally will be forgotten and in need of rebuilding. FIG. 18 is an exemplary diagram demonstrating how a characteristic router's cache unintentional expiration can effectively de-link the downstream tree from the rest of the routing tree. FIG. 18 shows an internetwork of characteristic routers (identified as reference odd numbers 601-621) with a routing tree that would have been built or that was previously built by a trailblazing packet (for destination characteristics met by characteristic routers 607, 609 and 611) originally sent from characteristic router 601. This routing tree (indicated by arrows) includes routers 601, 603, 605, 607 with leaves to routers 609 and 611. If the first trailblazing packet never arrived at characteristic router 603 or a cache entry times out just before another characteristic packet arrives at characteristic router 603, then the downstream routing tree is de-linked (as indicated by the “X”) from the rest of the routing tree. In both cases, a non-trailblazing characteristic packet with only the globally unique identifier arrives at characteristic router 603.

The system according to the present invention is capable of addressing this potential problem. FIGS. 19 and 20 are exemplary diagrams demonstrating how the present invention addresses the potential problem of a characteristic router's cache unintentional expiration. FIGS. 19 and 20 show the same internetwork of characteristic routers (identified as reference odd numbers 601-621) as in FIG. 18, and also deals with the same routing tree as discussed in FIG. 18. As seen in FIG. 19, a non-trailblazing characteristic packet (indicated by arrow 631) with only the globally unique identifier arrives at characteristic router 603. In response to receiving a non-trailblazing characteristic packet with only the globally unique identifier, a characteristic router according to a specific embodiment of the invention sends upstream a message with the CHARCAST_ORIGINAL_CHARACTERISTICS_REQUEST flag set. Therefore, characteristic router 603 would send such a message upstream (indicated by arrow 633) to characteristic router 601 that acts as a request to the upstream characteristic router 601, which does have the original characteristics information, to send that characteristics information downstream in a trailblazing packet with the CHARCAST_ORIGINAL_CHARACTERISTICS flag set. (Although the example of FIG. 19 only shows a one-hop solution to the encountered problem, it should be noted that the message sent upstream to request the original characteristics information will propagate as far up the tree as is necessary to obtain the information.) Then, as seen in FIG. 20, characteristic router 601 responds by sending the trailblazing packet (indicated by arrow 635) with the CHARCHAST_ORIGINAL_CHARACTERISTICS flag set to characteristics router 603. Upon arrival of the trailblazing packet with this flag set, a new cache entry is created in the forwarding cache of characteristic router 603, and the trailblazing packet is forwarded downstream in order to create the downstream routing subtree (formed by arrows from characteristic routers 603 to 605 to 607 to both 609 and 611) and thus form the desired routing tree (indicated in FIG. 20 by all the arrows with the exception of arrow 635).

According to specific embodiments, characteristic routers use augmented protocols such as CharOSPF, CharRIP or CharBP to discover the network topology and automatically configure a routing table based on characteristics for each destination in the network. According to these embodiments, characteristic routers also create forwarding cache entries using the characteristic routing table index to determine the set of destinations for the characteristic packet. As mentioned above, cache entries are created when a characteristic router first sees a characteristic packet (such as a trailblazing packet) for a particular <sender, destination characteristics> combination. The creation of cache entries by characteristic routers in accordance with specific embodiments using CharOSPF, CharRIP and CharBP may vary slightly, as discussed below.

Using CharOSPF, upon arrival of the first characteristic packet for a particular <sender, destination characteristics> combination, a characteristic router performs a SPF calculation in order to determine the shortest-path routing tree through the network for this <sender, destination characteristics> combination. When performing the SPF calculation, only CharOSPF routers are taken into account and pre-set tiebreakers are used so that all routers will create exactly the same routing tree. This routing tree is rooted at the sender and has the set of destinations as the leaves. From this routing tree, the characteristic router extracts the set of next-hop neighboring routers to which a copy of the characteristic packet will be sent. If only the destination information obtained from the routing table index were used and the SPF calculation were not performed, then the routing tree might contain cross-branches that simply incur control message overhead because they need to be pruned. However, these cross-branches can be removed and their pruning eliminated by performing the SPF calculation in accordance with this specific preferred embodiment using CharOSPF, resulting in an optimal routing tree.

Using CharRIP, upon arrival of the first characteristic packet for a particular <sender, destination characteristics> combination, a characteristic router uses the characteristic routing table index to determine the set of destinations for the characteristic packet. From this set of destinations, the characteristic router determines the set of next-hop neighboring routers to which a copy of the characteristic packet will be sent. It is noted that this embodiment may result in cross-branches that need to be pruned.

Using CharBP, a broadcast-and-prune protocol, a characteristic router periodically broadcasts to its neighbors the list of known sources and the router's distance (in router hops) to each source. Initially, a routing tree that includes all of the subnets in the network is created. Upon arrival of the first characteristic packet for a particular <sender, destination characteristics> combination, this first packet is broadcast on this initial routing tree to all subnets. In order to avoid forwarding loops from occurring, the characteristic packet will be forwarded by the characteristic router if the packet arrived from the neighboring router on the shortest path back to the source. The characteristic router uses its stored knowledge of the shortest source distances in order to make this forwarding determination. When one of the characteristic packet copies reaches a leaf routing node, that characteristic router node will determine if the destination characteristics area of the characteristic packet intersects the characteristics areas of its incident networks. If it does not, then the characteristic router node responds to its upstream neighboring characteristic router that the characteristic router node should be pruned from the routing tree node. If this upstream neighboring characteristic router does not have incident networks that intersect the packet's destination characteristics and if all of its downstream neighboring characteristic routers indicate that they also do not by sending prune messages, then this upstream characteristic router also sends a prune message to its upstream neighboring characteristic router. In this specific embodiment, this would occur repeatedly until the initial routing tree has been pruned back to the optimal routing tree that only includes paths to those subnets whose characteristic reach intersects with the characteristic packet's destination characteristics.

E. Exposing Route Information

For some applications of the technology, it may be useful to discover the actual routing paths and the potential recipients for a characteristically routed message. Since the routers already maintain much of the information, ideally applications would be able to interrogate their local router for this information. However, whereas each characteristic router maintains a view of the network in its network database and routing table that is consistent with all of the other characteristic routers, it does not contain a complete or detailed map of the network. The necessary information is actually scattered in a distributed manner throughout all of the routers.

Therefore, in order to enable such route and recipient discovery, in this specific embodiment a peek trailblazer will be provided. This peek trailblazer will perform the same route discovery on the outbound journey (from the sender to the set of receivers) that the normal trailblazer packet performs, but it does not cause the installation of any state information within the routers that process it. Instead, on the return journey from the receivers to the sender, it will collect and forward all route and recipient information to the sender. The end result is that the sender will know the identity and number of receivers for a specific set of characteristics and the routing tree from the sender to those receivers.

III. Hierarchial Characteristic Routing Embodiments

In some specific embodiments where it is desired to reduce the size of the routing tables and to minimize the network area affected by a change in a node's characteristics, hierarchical characteristic routing techniques can be used. Such specific embodiments are described below in more detail.

A. General

In order to reduce routing table sizes, collections of contiguous networks and hosts can be grouped together into a single whole. Such a group, together with the routers having interfaces to any one of the included networks, is called an area. Each area internally runs a separate copy of the basic characteristic routing algorithm. Externally, each area appears to be a single node on the network. Note that hierarchies can consist of multiple levels.

Whereas, the topology of an area is invisible from the outside of the area, a summary of all of the characteristics of all the networks within the area is advertised for the area. Conversely, just as routers internal to a given area know nothing of the detailed topology external to the area, they in turn have summaries of external areas. In accordance with this specific embodiment, this isolation of knowledge enables the characteristic routing protocol to effect a marked reduction in routing traffic as compared to treating the entire network as a single routing domain.

In order to be able to route to characteristic destinations outside of the area, the area border routers inject additional characteristic routing information into the area. Each border router summarizes the list of characteristics of its attached areas for transmission to other area border routers.

In order to create a summary of the total list of characteristics for an area, the network characteristic destinations for all of the networks within the area are logically OR-ed together. According to this specific embodiment, each network characteristic destination is stored as a Bloom filter, as will be discussed in more detail below. The bit vector resulting from the logical OR operation is a Bloom filter that will correctly identify all of the characteristics within the area. This new summary Bloom filter is what is advertised to other border routers.

A border router then has the area summaries from each of the other border routers. From this information, the border router calculates paths to all inter-area destinations. The router then advertises these paths into its attached areas. This enables the area's internal routers to pick the best exit border router when forwarding traffic to inter-area destinations. If the hierarchy consists of multiple levels, each level is treated in the exact same manner.

As described above in the section entitled “Approximating a Set of Characteristics”, if the network is using an “open” set of characteristics, it is possible that the number of characteristics can become large enough to put a strain on the system or, at least, make the resulting packet headers too large. Therefore, approximations using various compression techniques are useful for some specific embodiments in order to reduce the number of characteristics that the system uses for characteristic routing. For example, given a large string, compression techniques such as Lempel-Ziv or Bloom filters (of course, other compression techniques are possible in other specific embodiments) obtain space savings by creating a small set of substrings with which the whole original string can be recreated. The substrings and the instructions of how to use the substrings are then stored to recreate the original string. For characteristic routing purposes, the substring can be used as an approximation of the original set of characteristics. The senders and the routers would use this approximation technique. The first packet in a stream of packets would still have to send the original list of destination characteristics so that the endpoints can determine if these packets are really meant for them or not. Because the compression techniques reduce the number of strings from the original number of characteristics to the smaller number of substrings, the characteristic routers in these embodiments have to do less comparison work, and therefore can route faster. Also, the routing tables would be significantly smaller.

Because of the loss of specificity, characteristic packets in these embodiments may be forwarded to nodes that shouldn't have received these packets in the first place and the resulting routing tree will contain extra erroneous branches that should be pruned. If a characteristic router detects that no downstream routers are viable destinations for a message and that it itself is not a destination of the characteristic message, then it will send a “prune” message upstream toward the source of the characteristic message. When a characteristic router receives a prune message for a specific characteristic message, it removes that downstream router from the routing cache entry (if any) for that characteristic message. If this causes the number of downstream routers to drop to zero, then the characteristic router will itself send a prune message upstream.

A specific embodiment with an approximated set of characteristics using Bloom filters is described below as an example.

B. Encoding Characteristics with Bloom Filters

To reduce the memory requirements of the system according to this specific embodiment, each network characteristic destination is stored as a Bloom filter. This embodiment provides a computationally efficient, hash-based probabilistic scheme that can represent a set of keys in the form of arbitrary strings with minimal memory requirements, while answering membership queries with zero probability for false negatives and low probability for false positives.

A Bloom filter is a method for representing a set A={a₁, a₂, . . . , aₙ of n elements (also called keys) to support membership queries. Bloom filters (which are further described by Burton Bloom in “Space/Time Trade-offs in Hash Coding With Allowable Errors,” Communications of ACM, Vol. 13, No. 7, pp. 422-426, July 1970) have been used in the past in spell checkers and web page caches.

The idea behind Bloom filters is to allocate a vector ν of m bits, initially all set to 0, and then choose k independent hash functions, h₁, h₂, . . . , hₖ, each with range {1, . . . , m For each element aεA, the bits at positions h₁(a), h₂(a), . . . , hₖ(a) in ν are set to 1. (A particular bit might be set to 1 multiple times.) Given a query for b, the bits at positions h₁(b), h2(b), . . . , hₖ(b) are checked. If any of them is 0, then certainly b is not in the set A. Otherwise, b is conjectured to be in the set, although there is a certain probability that this conjecture is incorrect (called a “false positive”). The parameters k and m should be chosen such that the probability of a false positive (and hence a false hit) is acceptable.

The salient feature of Bloom filters is that there is a clear tradeoff between m and the probability of a false positive. After inserting n keys into a table of size m, the probability that a particular bit is still 0 is exactly

$${( 1 - \frac{1}{m} )}^{kn} .$$

Hence the Probability of a False Positive in this Situation is:

$${( 1 - {( 1 - \frac{1}{m} )}^{km} )}^{k} \approx {( 1 - {ⅇ}^{- kn / m} )}^{k} . \qquad \text{(equation 1)}$$

The right hand side of equation 1 is minimized for k=ln 2×m/n , in which case it becomes ½^{k}=(0.6185)^{m/n}. Thus, under optimal k, the probability of a false positive reduces exponentially as m increases. In practice, k must be an integer, and a value less than optimal may be chosen to reduce computational overhead.

The probability of a false positive is the ratio α=m/n, which is a function of the number of bits allocated for each entry. Bloom filters require little storage per key at the slight risk of some false positives. For instance, for a bit array 10 times larger than the number of entries, the probability of a false positive is 1.2% for 4 hash functions, and 0.9% for the optimum case of 5 hash functions. According to some specific embodiments, allocating more memory can easily decrease the probability of false positives. Therefore, in preferred specific embodiments, the number of hash functions, k, is between about 3 and 6, most preferably 4. For more accuracy with increased computational overhead, k should be 4 or greater in some specific embodiments.

Some useful properties of Bloom filters are as follows:

Bad Spots—If the underlying memory hardware detects errors and reports an error in some block, that data block can be replaced with ones, only slightly increasing the false hit frequency. No false negatives will be added.

Non Power of Two—If a bit string whose length is not a power of two is needed, then a virtual bit string whose length is the next larger power of two but whose additional bits are all one is produced but not actually stored. That is, whenever a bit index falls outside the string length, it is as if a one was seen and writes to those locations are ignored.

OR-ing together of filters—Different filters built at different places or different times can be logically OR-ed together to produce a filter that will recognize any globs recognized by any of its ancestors. OR-ing filters together results in higher densities, but reducing the density of contributing filters may ameliorate this.

Filter shrinking—If a filter has received fewer globs than originally planned, then its size may be halved by OR-ing together the left and right halves. Subsequent filter probes merely mask off the high bit of the bit offset. This may be integrated.

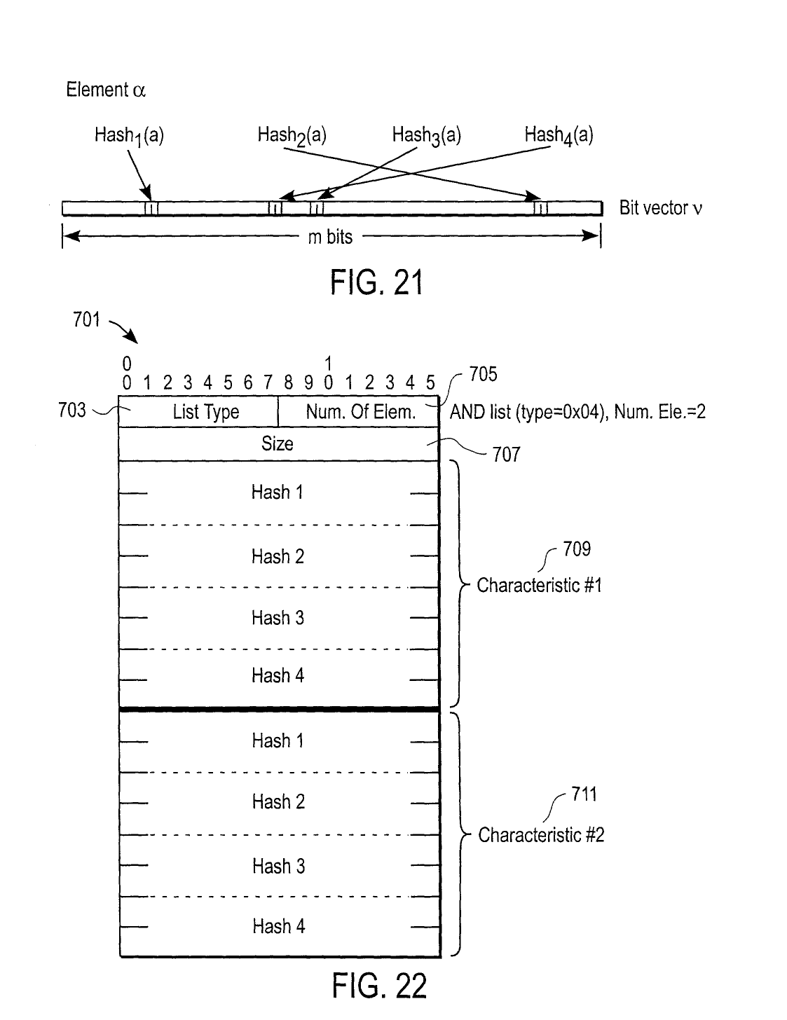

According to the specific embodiment, each network characteristic destination is stored as a Bloom filter. For this particular example, k=4 and each characteristic is represented by its four hash function results, as shown in FIG. 21. Each characteristic would be encoded as four 32-bit integers, each hash function result being a 32-bit integer in this specific example. The characteristic destination would be in the form of a list of characteristics. Because of the nature of Bloom filters, operations such as “RANGF” and “SIMILAR” (discussed previously) will not work for these specific embodiments using Bloom filters. As such, only the commands “AND” and “OR” may be used in these embodiments. Note that if no operation is given in a characteristic message, then the AND command is implied. Usage profiles also indicate that the majority of destinations make use of simple lists of characteristics that are then AND-ed or OR-ed together. Therefore, simplified AND and OR lists can be used.

FIG. 22 illustrates an encoding of a characteristic list 701 (this example shows an AND list having two list elements), in accordance with a specific embodiment for hierarchical characteristic routing. According to this example, each simple list encoding has the following information in this order: a Type field 703, an Element Number field 705, a Size field 707, and the encoded list elements 709 and 711. In this example, Type field 703 is a 1-byte field that is set to 0×04 to indicate an AND list or could be set to 0×08 to indicate an OR list; Element Number field 705 is a 1-byte field that is set to the number of elements in this list (since this field 705 is an 8-bit field, the list is limited to 256 elements; but a different bit sized field 705 could have other element limits as desired); Size field 707 is a 2-byte field that indicates the size of the list in bytes (the size includes the overall size of the list including the Type field 703, Element Number field 705, the Size field 707, and the elements 707 and 711 themselves); and the encoding of each list element. The overall size in this example is limited to 64 kilobytes but other limits to the size are possible in other examples. As discussed earlier, each list element is an encoded characteristic, and each characteristic is encoded by its four hash function results, according to this specific embodiment.

It is noted that using an approximation, such as through Bloom filters, of the set of characteristics for a characteristic destination provides a limit on the size of the bit vector representing any set of characteristics. Due to the limiting of the size of the bit vector representing any set of characteristics to a definitive predetermined size, the number of packets being transmitted and processed is reduced. Accordingly, router memory space requirements and computational overhead are minimized, while processing speed is desirably maximized.

C. Gathering Characteristics about a Network Segment

Since each router maintains a local Bloom filter to represent its total list of characteristics, changes to the set of characteristics (lets call it set A) must be supported. According to the specific embodiment, this is done by maintaining for each location l in the bit array a count c(l) of the number of times that the bit has been set to 1 (that is, the number of elements that hashed to l under any of the hash functions). All the counts are initially 0. When a key a (in our case a characteristic) is inserted or deleted, the counts C(h₁(a)), c(h₂(a)), . . . , c(hₖ(a)) are incremented or decremented accordingly (where h₁(a), h₂(a), . . . , hₖ(a) represent the results of running the k hash functions). When a count changes from 0 to 1, the corresponding bit is turned on. When a count changes from 1 to 0, the corresponding bit is turned off. Hence the local Bloom filter always reflects correctly the total list of characteristics.

D. Exchanging Routing Table Information

The router can either broadcast the entire bit array of the Bloom filter, the changes in the bit array, or let other routers fetch updates from it. Periodically, full updates should be sent. The exact method will be determined by the underlying routing protocol being used. A load factor between 8 and 16 works well, although routers can lower or raise it depending on their memory and network traffic concerns. Based on the load factor, four or more hash functions should be used in a specific embodiment.

The hash functions are built by first calculating the MD5 signature of the characteristic, which yields 128 bits, and then taking four groups of 32 bits from it. MD5 (as described by A. J. Menzes et al. in Handbook of Applied Cryptography, CRC Press, 1997) is a cryptographic message digest algorithm that hashes arbitrary length strings to 128 bits. According to a specific embodiment, MD5 is selected because of its well-known properties and relatively fast implementation. Other embodiments using other comparable algorithms are also possible. Note that all routers will be using the same hash functions.

The advantage of Bloom filters is that they provide a tradeoff between the memory requirement and the false positive ratio (which induces false hits). For routers, this translates into a tradeoff between bandwidth (in the form of extra packets being forwarded and extra receivers) and control overhead (in the form of memory requirements and the size of control packets between routers). Thus, if routers want to devote less memory to the summaries, they can do so at a slight increase of inter-router traffic.

E. Automatically Configuring into a Hierarchical Network

In some embodiments, it may be desirable to automatically configure the characteristic network into a hierarchical organization. Examples of operating environments where automatic hierarchical organization would be desirable would include wireless or low-bandwidth networks, wide-area networks, or large networks on the order of 200 routing nodes or greater.

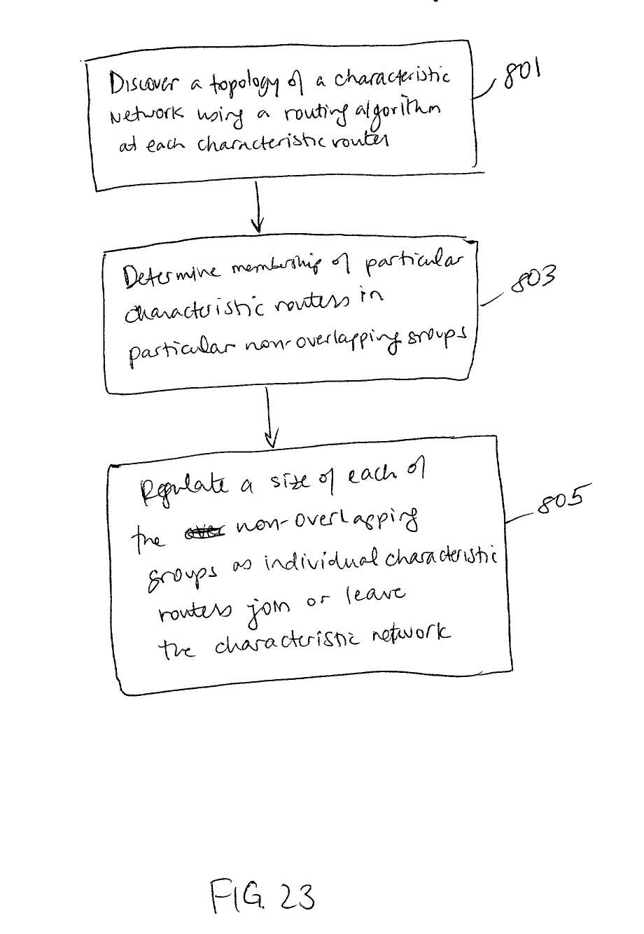

FIG. 23 shows a general example of the automatic configuration of a characteristic network into a hierarchical organization, according to specific embodiments.

Initially, the characteristic network would begin as a flat network without hierarchy. In order to automatically configure into a hierarchical network, each router in the network will initially need to know the topology of the entire network. Therefore, a routing algorithm such as CharOSPF would be needed to populate each router's network database with sufficient information. Each router would then execute the exact same algorithm in a step 801 (FIG. 23) to determine how to split the network into hierarchies. By using the same algorithm at each router, there is no need for central coordination since each router will arrive at the same solution separately.

The hierarchical algorithm that each router will execute includes in step 803 choosing non-overlapping groups of connected and contiguous routing nodes such that each routing node in the network belongs to exactly one group. Once a routing node is a member of a particular group, then, at a minimum, it would only need to maintain information in its network database about the nodes within the group and the identity of border routers within the group. Border routers, or routing nodes with connections to nodes in other groups, would need to maintain routing information about the network paths to other groups. According to specific embodiments, a border router on the edge between a network of higher bandwidth and a network of lower bandwidth will execute and translate between both a proactive and reactive algorithm in terms of network topology discovery and configuration of routing tables.

The size of each group would be regulated in step 805, such as by a system-wide maximum and minimum router node count. These thresholds could be varied depending on the network environment. For instance, when operating in a wireless network that is both resource-poor (i.e.—routing nodes with small amounts of memory such as random access memory (RAM)) and bandwidth-poor, the thresholds could be set at a lower setting in order to reduce the size of the routing tables at each node and to reduce the control traffic between nodes. As routing nodes either join or leave the network, affected groups need to review their node memberships to determine if the group as a whole has exceeded either threshold. If the maximum node number threshold is surpassed, then the group is divided into two groups. If the minimum node number threshold is exceeded, then the group is disbanded and the individual nodes are joined to other adjacent groups.

Membership in the groups would be determined through inspection of the relationships between the routing nodes. Ideally, it is desirable that each group contain a set of nodes that are adjacent, strongly connected to each other, and share a minimal number of border connections to nodes in other groups. In order to determine the sets of nodes that match this criteria, algorithms such as ones that find all maximal cliques or algorithms that find all strongly connected components would be employed on the network graph contained in the each router's network database. Note that other algorithms that divide a network graph into disjoint well-connected components could also be used. The components that result from such an algorithm would become the groups in the hierarchy.

Higher levels of the hierarchy would result from representing each group as a single routing node. The border routers in each group would maintain separate routing tables for each level of hierarchy. The border routers within a group could cooperate and share information to jointly represent the group to the hierarchy and perform routing duties for packets entering and leaving the group. Alternatively, a single border router could be elected to represent the group to the hierarchy and perform all routing duties for packets that enter or leave the group.

IV. Low-Bandwidth Unreliable Networks

Networks that are resource-poor, low-bandwidth, and unreliable do not allow for the same proactive routing embodiments discussed herein. Examples of such networks would include wireless ad-hoc networks and sensor networks. In such networks, the main concern would be minimizing the amount of control overhead needed in order to achieve a proper routing of packets to the correct recipients.

Because of the resource constraints, such as small memory sizes and limited energy supplies, a more reactive routing approach needs to be employed. This is different from the proactive characteristic routing described above. Proactive routing first discovers the topology of the network before attempting to route a packet to the relevant data sources (those nodes meeting characteristics defined by the packet). As part of the process, each characteristic router within the network has a consistent map of the network and the location of the data throughout the network. In reactive routing, each characteristic router will wait until a user actually sends a packet before discovering the appropriate path information needed to properly forward the packet toward the set of destinations. The first router to receive the packet will flood the network with a route discovery request for a particular set of destination characteristics. When a node is reached that matches the destination characteristics, it will respond with an acknowledgement back toward the first characteristic router. As the acknowledgement travels back to the first router, intermediate routers will cache in soft state in its routing table forwarding information for that set of characteristics to the acknowledging destination node. Once all matching destinations have sent their acknowledgements, the result is a routing tree rooted at the first characteristic router.

To further reduce the control overhead, small Bloom filters will be used. Reducing the size of Bloom filters involves a trade-off between reducing the control overhead and the accuracy of routing the query. To reduce the Bloom filter, the actual size of the bloom filter bit vector can be reduced. As long as the size of the bloom filter is a power of two, then it will be straightforward to expand the bloom filter at a border routing node at the junction between the wired and wireless data networks. Also, the number of hash functions used to encode each unique data item could be reduced. Reducing the number of hash functions increases the probability that overlapping hashes will result in false positives. For example, in the preferred embodiment discussed above, four hash functions derived from an MD5 encoding were used to encode each unique data item. In other embodiments, the same MD5 encoding could be used as the hash function, but instead of dividing the resulting encoding into four hash values, the whole encoding could be used as a single hash value modulo the size of the bloom filter bit vector. Also in other embodiments, the MD5 encoding can be halved and the two halves (number of hash functions is 2) used as the two hash values each modulo the size of the bloom filter bit vector. Reducing the bloom filter means that less information needs to be shared between routers. However, when deciding where to route a query, the size reduction or the reduction in hash functions also results in an increase in the number destinations that seem to contain information relevant to the query because of the higher false-positive rate. Since the Bloom filter is an approximation of the data at a data source, a reduced Bloom filter is a coarser approximation of the same.

V. Conclusion

The description above describes specific embodiments, and it is understood that the present invention is not necessarily limited to the described embodiments. Variations or modifications of the described embodiments could be made without departing from the scope of the invention. The scope of the invention is to be limited only by the issued claims.

What is claimed:

1. A method for routing a packet from over a network including multiple nodes, said method comprising steps of:
receiving a packet from a sender node over said network, wherein said packet is intended for at least one destination node having a plurality of defined characteristics, said plurality of defined characteristics being determinable by said sender node, and wherein said packet includes information on said plurality of defined characteristics;
said receiving step occurring at said at least one destination node having said plurality of defined characteristics;
wherein said plurality of defined characteristics is a subset of or a total set of multiple, arbitrary characteristics describing aspects of said multiple nodes in said network;
discovering a topology of said network based on said total set of multiple arbitrary characteristics, wherein said network couples said sender node, said at least one destination node, and at least one routing node, and wherein said discovering step is performed proactively before said packet is sent from said sender node and before said packet is received at said at least one destination node;
forwarding to said sender node a routing table including entries based on said particular characteristics of each node in network portions, wherein said routing table is not configured at each routing node; and
sending a copy of said packet based on said entries in said routing table.

2. The method of claim 1 wherein said discovering step is performed using a peek trailblazer packet.

3. The method of claim 1 wherein said packet includes said information on said plurality of defined characteristics in a header of said packet.

4. The method of claim 1 wherein said packet further includes an IP address, wherein said IP address may be a unicast or multicast address.

5. The method of claim 1, wherein each of said entries is a bit vector of said total set of multiple arbitrary characteristics, each of said multiple arbitrary characteristics having a predefined bit location in said bit vector.

6. The method of claim 1, wherein said packet includes said information on said plurality of defined characteristics in a predetermined location in a payload of said packet.

7. The method of claim 1, further comprising a step of sending said packet from said sender node, wherein said sending step uses a compression technique.

8. The method of claim 7, wherein each of said entries is an approximated bit vector of said total set of multiple arbitrary characteristics, and wherein said compression technique results in an approximated bit vector of said information on said plurality of defined characteristics.

9. A method for routing a packet over a network including multiple nodes, said method comprising steps of:
sending a packet from a sender node over said network, wherein said packet is intended for at least one destination node having a plurality of defined characteristics, said plurality of defined characteristics being determinable by said sender node, and wherein said packet includes information on said plurality of defined characteristics, wherein said plurality of defined characteristics is a subset of or a total set of multiple, arbitrary characteristics describing aspects of said multiple nodes in said network;
discovering a topology of said network based on said total set of multiple arbitrary characteristics, wherein said network couples said sender node, said at least one destination node, and at least one routing node, and wherein said discovering step is performed reactively after said packet is sent from said sender node and said packet is received at the first of said routing nodes;
configuring a routing table in soft state at each routing node of said topology of network portions intermediate respective to said first of said routing nodes, said routing table including entries based on said particular characteristics of each node in said network portions; and
sending a copy of said packet based on said entries in said routing table to said at least one destination node having said plurality of defined characteristics.

10. The method of claim 9 wherein said discovering step includes said first of said routing nodes sending a route discovery request for said plurality of defined characteristics to destination nodes, and receiving from said destination nodes meeting said plurality of defined characteristics an acknowledgement.

11. The method of claim 9 wherein said packet includes said information on said plurality of defined characteristics in a header of said packet.

12. The method of claim 9 wherein said packet further includes an IP address, wherein said IP address may be a unicast or multicast address.

13. The method of claim 9, wherein each of said entries is a bit vector of said total set of multiple arbitrary characteristics, each of said multiple arbitrary characteristics having a predefined bit location in said bit vector.

14. The method of claim 9, wherein said packet includes said information on said plurality of defined characteristics in a predetermined location in a payload of said packet.

15. The method of claim 9, further comprising a step of sending said packet from said sender node, wherein said sending step uses a compression technique.

16. The method of claim 15, wherein each of said entries is an approximated bit vector of said total set of multiple arbitrary characteristics, and wherein said compression technique results in an approximated bit vector of said information on said plurality of defined characteristics.

17. The method of claim 16, wherein said compression technique comprises use of Bloom filters including a Bloom filter bit vector and a number of hash functions.

18. The method of claim 17 wherein a size of said Bloom filter bit vector is reduced when said network is unreliable and/or has low bandwidth.

19. The method of claim 17 wherein said number of hash functions is reduced when said network is unreliable and/or has low bandwidth.

20. The method of claim 19 wherein said number of hash functions comprises less than 4.

21. The method of claim 17 wherein said hash functions are derived from an MD5 encoding.

22. The method of claim 21 wherein said number of hash functions comprises 1 and said MD5 encoding is used as a single hash value modulo a size of said Bloom filter bit vector.

23. The method of claim 22 wherein said size of said Bloom filter bit vector is reduced when said network is unreliable and/or has low bandwidth.

24. A method for efficient hierarchical routing in a low bandwidth network or in an unreliable network, said method comprising steps of:
representing a set of characteristics for a characteristic destination as a bit vector;
approximating the set of characteristics to provide a limit on an overall size of the bit vector representing the set of characteristics, said approximating step comprising utilizing a compression technique comprising Bloom filters; and
transmitting over the network a message utilizing the approximated set of characteristics.

25. The method of claim 24, wherein:
said Bloom filters have a Bloom filter bit vector comprising said bit vector and a number of hash functions less than 4.

26. The method of claim 25 wherein a size of said Bloom filter bit vector is reduced.

27. The method of claim 25 wherein said hash functions are derived from an MD5 encoding.

28. The method of claim 27 wherein said number of hash functions comprises 1 and said MD5 encoding is used as a single hash value modulo a size of said Bloom filter bit vector.

29. A method of automatically configuring a characteristic network into a hierarchical organization, said characteristic network including a plurality of characteristic routers and a plurality of nodes, said method comprising the steps of:
discovering a topology of said characteristic network using a routing algorithm at each characteristic router, said routing algorithm including choosing a plurality of non-overlapping groups of characteristic routers that are connected and contiguous such that each characteristic router in said characteristic network belongs to exactly one group;
determining membership of particular characteristic routers in particular non-overlapping groups by inspecting relationships between said characteristic routers; and
regulating a size of each of said plurality of non-overlapping groups as individual characteristic routers either join or leave said characteristic network.

30. The method of claim 29 wherein said determining step groups characteristic routers such that each group contains characteristic routers that are adjacent, strongly connected to each other, and share a minimal number of border connections to characteristic routers in other groups.

31. The method of claim 30 wherein an algorithm finding all maximal cliques can be employed in said determining step.

32. The method of claim 30 wherein an algorithm finding all strongly connected characteristic routers can be employed in said determining step.

33. The method of claim 29 wherein said regulating step includes specifying a system-wide maximum node count and a minimum node count, said maximum node count and said minimum node count each being able to be specified depending on the environment of said characteristic network.

34. The method of claim 33 wherein said regulating step includes each group reviewing its membership of nodes to determine if that group as a whole has exceeded either said maximum node count or said minimum node count.

35. The method of claim 34 wherein each group divides into a plurality of groups if the maximum node count is exceeded by its current membership of nodes.

36. The method of claim 35 wherein said plurality of groups comprises two groups.

37. The method of claim 35 wherein each group disbands when its minimum node count is not met by its current membership of nodes, with nodes in said disbanded group join other adjacent groups.

38. The method of claim 34, wherein said maximum node count or said minimum node count can be specified at a low setting when said characteristic network comprises a bandwidth poor, resource poor wireless network.

39. The method of claim 29 wherein each non-overlapping group can be represented as a single routing node to provide for higher levels of hierarchical organization.

40. The method of claim 39 wherein border characteristic routers in each group maintain separate routing tables for each level of hierarchy and border characteristic routers in each group perform routing duties for packets entering and leaving the group.

41. The method of claim 40 wherein said border characteristic routers in each group also cooperate with each other to share information to jointly represent their group to the hierarchy.

42. The method of claim 39 wherein a single border characteristic router in each group performs all routing duties for packets entering and leaving the group.

43. The method of claim 42 wherein said single border characteristic router in each group is elected to represent the group to the hierarchy.

44. The method of claim 21 wherein said number of hash functions comprises 2 and said MD5 encoding is halved and the two halves are used as the two hash values each modulo a size of said Bloom filter bit vector.

45. The method of claim 1 wherein a border router on the edge between a network of higher bandwidth and a network of lower bandwidth will execute and translate between both a proactive and reactive algorithm in terms of said discovery step and said routing table configuration.

46. The method of claim 9 wherein a border router on the edge between a network of higher bandwidth and a network of lower bandwidth will execute and translate between both a proactive and reactive algorithm in terms of said discovery step and said routing table configuration.

47. The method of claim 22 wherein a border router on the edge between a network of higher bandwidth and a network of lower bandwidth will execute and translate between both a proactive and reactive algorithm in terms of said discovery step and said routing table configuration.

48. The method of claim 27 wherein said number of hash functions comprises 2 and said MD5 encoding is split into two and used as two hash values modulo a size of said Bloom filter bit vector.
